(19) United States
(12) Patent Application Publication
(10) Pub. No.: US 2008/0217391 A1
(43) Pub. Date: Sep. 11, 2008

(54) OPTICAL MARKINGS

(75) Inventors: William Harold Roof, San Diego, CA (US); Robert N. Williamsen, Evergreen, CO (US); David Dale Swenson, Encinitas, CA (US)

Correspondence Address: KNOBBE MARTENS OLSON & BEAR LLP, 2040 MAIN STREET, FOURTEENTH FLOOR, IRVINE, CA, 92614, US

(73) Assignee: IntelliDOT Corporation, San Diego, CA (US)

(21) Appl. No.: 11/669,718

(22) Filed: Jan. 31, 2007

(51) Int. Cl. G06K 19/06; G06F 17/30; G06F 3/08; G06F 17/40

(52) U.S. Cl. 235/375; 707/104.1; 707/10; 235/462.01; 235/494; 707/E17.032

(57) ABSTRACT

A method and system for cumulatively associating manufacture data and patient data with disposable equipment, particularly sample collection containers, in a medical or laboratory environment by permanently affixing unique code labels to the disposable equipment.

### BACKGROUND OF THE INVENTION

1. Field of the Invention

This invention relates to labeled disposable equipment in a medical or laboratory environment. More specifically, the invention relates to equipment with a permanently affixed and unique code label.

2. Description of the Related Art

In a hospital or laboratory environment, equipment is used to treat a single patient and then disposed. Methods for collectively associating manufacturing data and/or patient data with equipment designed for specific medical or laboratory needs may reduce careless and/or inadvertent mistakes made vis a vis a patient and an associated test or sample.

Handwritten information on disposable equipment is not easily converted into electronic form; processing of sample collection containers labeled with handwritten information must also occur manually. A handwritten label may be created, for example, from a lab order slip. This type of label may be more prone to transcription errors than a computer generated label. Further, handwritten information is not easily available to remote users or computer applications.

Disposable equipment may also be manufactured with computer generated barcodes. Nevertheless, current manufacturer barcodes are not unique to individual equipment, e.g. a test tube. Thus, a single barcode may indicate any one of millions of test tubes from the same manufacturing lot.

Computer generated labels in a medical environment do not contain manufacturing data for a piece of disposable equipment. Although barcodes on these labels may be unique within a particular medical environment they cannot be guaranteed to be unique outside of that medical environment. Although barcodes may be associated with serialized equipment, use of barcodes is limited. For example, because billions of test tubes are produced per year, linear barcodes do not carry enough digits to uniquely number all test tubes (due to space restrictions).

Sometimes, a second barcode label may be affixed to the test tube after certain tests are ordered at a hospital. These types of labels may contain patient identification information. For a petite sample collection container, space for hand-written information, which may be required by hospital policy, is thus severely restricted. Further, multiple barcodes on a single container may cause difficulty when attempting to scan a particular barcode.

Other types of labels are also available for identifying products and equipment. For example, there are bar codes and two-dimensional codes that can encode over 19 billion billion unique numbers. Some two-dimensional codes are substantially circular and can be approximately 5 mm in diameter.

### SUMMARY OF THE INVENTION

In one embodiment a method of manufacturing a uniquely identifiable disposable medical or laboratory equipment comprises providing disposable medical or laboratory equipment with a permanently affixed code label and associating manufacture data of the disposable medical or laboratory equipment with the code label using a scanner configured to read the code label. In some embodiments the disposable laboratory equipment is a sample collection container. In some embodiments the code label comprises at least one of a barcode and a DOT. In some embodiments the manufacture data comprises at least one of a lot number, a place of manufacture, a type of sample tube, a date of manufacture, an expiration date and at least one chemical additive. In some embodiments the sample collection container is a sample tube.

In another embodiment a method of controlling processes in a medical work flow system comprises permanently affixing a unique code label to medical or laboratory equipment, associating the medical or laboratory equipment manufacture data with the code label and associating patient data with the code label. In some embodiments the disposable medical or laboratory equipment is a sample collection container. In some embodiments the method further comprises providing the sample collection container to a health care worker. In some embodiments the code label comprises at least one of a barcode and a DOT. In some embodiments the manufacture data comprises at least one of a lot number, a place of manufacture, a type of sample collection container, a date of manufacture, an expiration date and a chemical additive. In some embodiments the method further comprises scanning a patient identification. In some embodiments the patient identification comprises a wristband. In some embodiments the method further comprises scanning a nurse identification badge. In some embodiments the method further comprises scanning a hospital employee identification badge. In some embodiments the patient data comprises at least one of a patient name, a patient age, a patient date of birth, a hospital name, a phlebotomist electronic signature, a time of use of the sample tube, a patient record number, a patient diagnosis, a type of patient sample and a set of ordered tests.

In another embodiment a uniquely identifiable sample collection container comprises a sample collection container and a unique code permanently affixed to the sample collection container, wherein the sample collection container manufacture data is associated with the code. In some embodiments the unique code comprises at least one of a barcode and a DOT. In some embodiments the manufacture information comprises at least one of a lot number, a place of manufacture, a type of sample tube, a date of manufacture, an expiration date and at least one chemical additive. In some embodiments the sample collection container is a sample tube.

In another embodiment a system for uniquely identifying medical or laboratory equipment in a medical or research environment comprises medical or laboratory equipment, a unique code label permanently affixed to the medical or laboratory equipment and a hand held scanner configured to cumulatively associate with the code label at least one of manufacturer data and patient data. In some embodiments the medical or laboratory equipment is a sample collection container. In some embodiments the scanner is configured to alert a user to specific sample collection container manufacture data. In some embodiments the manufacture data comprises at least one of a lot number, a place of manufacture, a type of sample tube, a date of manufacture, an expiration date and at least one chemical additive. In some embodiments the patient data comprises at least one of a patient name, a patient age, a patient date of birth, a hospital name, a phlebotomist electronic signature, a time of use of the sample tube, a patient record number, a patient diagnosis, a type of patient sample and a set of ordered tests. In some embodiments the hand held scanner further comprises a wireless transceiver. In some embodiments the hand held scanner further comprises a processor.

In another embodiment a method of storing or delivering milk to an infant comprises providing a uniquely identifiable sample collection container configured to store milk for an infant, providing a label permanently affixed to the uniquely identifiable sample collection container, wherein the label comprises a code, wherein the code is associated with manufacture data about the sample collection container, patient data about the infant and the origin of the milk, providing milk from a milk provider and delivering the sample collection container and the milk to an infant. In some embodiments the method further comprises storing the sample collection container and the milk. In some embodiments the sample collection container is a bottle or a jar.

### BRIEF DESCRIPTION OF THE DRAWINGS

These and other aspects of the invention will be readily apparent from the description below and the appended drawings, in which like reference numerals refer to similar parts throughout, which are meant to illustrate and not to limit the invention, and in which:

FIG. 1 is a block diagram of one embodiment of a medical management system.

FIG. 2 is a block diagram of one embodiment of a server used in the medical management system shown in FIG. 1.

FIG. 3A is a block diagram of components within one embodiment of a wireless terminal.

FIG. 3B is a block diagram of one embodiment of a plurality of modules communicating with the microcontroller of a wireless terminal.

FIG. 4 is a flowchart illustrating one embodiment of a method of operating a wireless terminal in the medical management system.

FIG. 5 is a flowchart illustrating one embodiment of a method of operating a wireless terminal during a communication session with the server.

FIG. 6 is a flowchart illustrating one embodiment of a method of operating the server during a communication session with a wireless terminal.

FIG. 7 is a flowchart illustrating one embodiment of a method of operating the server.

FIG. 8 is a flowchart illustrating one embodiment of a method of operating the information update module in the server.

FIG. 9 is a flowchart illustrating one embodiment of a method of operating the messaging module in the server.

FIG. 10 is an exemplary illustration of one embodiment of a Medication Worksheet for use in a medical management system.

FIG. 11 is an exemplary illustration of one embodiment of a configuration report used to configure a wireless terminal.

FIG. 12 is a block diagram of one embodiment of a pharmaceutical tracking system.

FIGS. 13A-B are a flow diagram illustrating one method of operation of the pharmaceutical tracking system of FIG. 1.

FIG. 14 is a software flow diagram illustrating one embodiment of a method of processing an authentication code verification request at the server/database of the pharmaceutical tracking system.

FIG. 15 is a block diagram of a manufacturer system connected to a hospital system.

FIG. 16 is a flowchart illustrating a method of manufacturing sample collection containers with permanently affixed unique codes.

FIG. 17 is a flowchart illustrating a method for entering manufacturing data into a hospital inventory database.

FIG. 18 is a flowchart illustrating a method for linking patient data to a sample collection container in a patient database.

FIG. 19 is a flowchart illustrating a process for assuring quality control.

FIG. 20 is a flowchart illustrating a method for linking laboratory results to a sample collection container.

FIG. 21 is a flowchart illustrating a process for approving billing.

FIG. 22A shows a prior art sample collection container.

FIG. 22B shows one embodiment of a sample collection container.

FIG. 22C shows another embodiment of a sample collection container.

### DETAILED DESCRIPTION

Embodiments of the present disclosure provide significant improvements to sample collection containers and disposable equipment technology. Such sample collection containers and disposable equipment (hereinafter collectively “sample collection containers”) are often found in hospitals or laboratories where large numbers of samples must be organized or stored. Types of sample collection containers are described in more detail below. Methods and systems for uniquely identifying each sample collection container can be used to identify manufacturing information related to the sample collection container (“manufacturing information”) and/or information related to the sample contained within the sample collection container and/or information related to the patient that produced the sample (“patient or sample information”). Manufacturing information and patient or sample information are discussed further below.

In an embodiment, a uniquely identifiable sample collection container comprises a sample collection container and a unique code permanently affixed to the sample collection container (“a code label”), wherein the sample collection container manufacture data is associated with the code. In some embodiments the unique code comprises a bar code. In some embodiments the unique code comprises a two-dimensional code. In some embodiments a two-dimensional code comprises an “intelliDOT” (“DOT”). In some embodiments the manufacture information comprises at least one of a lot number, a place of manufacture, a type of sample tube, a date of manufacture, an expiration date and at least one chemical additive.

Some embodiments of the present disclosure include systems and methods for manufacturing uniquely identifiable sample collection container. In some embodiments the method comprises providing a sample collection container with a code label and associating manufacture data of the sample collection container with the code label using a scanner configured to read the code label.

Some embodiments of the present disclosure include methods of controlling processes in a medical or laboratory work flow system. In some embodiments the method comprises permanently affixing a code label to a sample collection container, associating the sample collection container manufacture data with the code label and associating patient or sample information with the code label. In some embodiments the patient or sample information comprises at least one of a patient name, a patient age, a patient date of birth, a hospital name, a phlebotomist electronic signature, a time of use of the sample tube, a patient record number, a patient diagnosis, a type of patient sample and a set of ordered tests. In some embodiments the method further comprises providing the sample collection container to a health care worker. In some embodiments the method further comprises scanning a patient identification. In some embodiments the method further comprises scanning a nurse identification badge. In some embodiments the method further comprises scanning a hospital employee identification badge.

Other embodiments of the present invention include a system for uniquely identifying sample tubes in a medical or research environment. Some embodiments comprises a sample tube, a code label permanently affixed to the sample tube and a hand held scanner configured to cumulatively associate with the code label at least one of manufacturer data and patient data. In some embodiments the scanner is configured to alert a user to specific sample tube manufacture data. In some embodiments the hand held scanner further comprises a wireless transceiver. In some embodiments the hand held scanner further comprises a processor.

Embodiments of the invention will now be described with reference to the accompanying Figures. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

This application incorporates by reference in their entirety U.S. patent application Ser. No. 10/824,130, filed Apr. 13, 2004, and U.S. patent application Ser. No. 10/857,701, filed May 28, 2004.

### DEFINITIONS

As used herein, “instructions” refer to computer-implemented steps for processing information in the system. Instructions can be implemented in software, firmware or hardware and include any type of programmed step undertaken by components of the system.

As used herein, a “code which corresponds to instructions” or a “code corresponding to an instruction” means a code that refers to, or is converted into, one or more instructions to be carried out in the system. For example, a code “ABC123” might point to an instruction that results in a doctor being paged to a particular room. Codes and their corresponding instructions can be stored in a database or lookup table so that scanning in a code causes the terminal to lookup the code in the database and retrieve its corresponding instruction, or set of instructions. As described, codes are preferably converted into 1D or 2D symbols so that they can be conveniently scanned into the system.

As used herein, the term “module” refers to the various modules in the system as discussed in detail below. As can be appreciated by one of ordinary skill in the art, each of the modules comprises various sub-routines, procedures, definitional statements and macros. Modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

As used herein, the term “programming language” refers to any programming language such as C, C++, BASIC, Pascal, Java, FORTRAN, and Assembly Language and ran under the well-known operating system. C, C++, BASIC, Pascal, Java, and FORTRAN are industry standard programming languages for which many commercial compilers can be used to create executable code.

As used herein, the term “code reader” refers to a device that reads machine readable codes. Preferably, the codes are affixed to a package or product. Examples of code readers include barcode readers, scanners, and two-dimensional code readers such as that described in U.S. Pat. No. 6,601,772, issued on Aug. 5, 2003 and herein incorporated by reference in its entirety.

As used herein, a “microprocessor” may be any conventional general purpose single- or multi-chip microprocessor such as a Pentium® processor, a Pentium® Pro processor, a 8051 processor, a MIPS® processor, a Power PC® processor, or an ALPHA® processor. In addition, the microprocessor may be any conventional special purpose microprocessor such as a digital signal processor or a graphics processor. The microprocessor typically has conventional address lines, conventional data lines, and one or more conventional control lines.

As used herein, an “input device” can be, for example, a keyboard, roller ball, mouse, voice recognition system, or other device capable of receiving information from a user and transmitting it to a computer. The input device can also be a touch screen associated with the display, in which case the user responds to prompts on the display by touching the screen. The user may enter textual information through the input device such as the keyboard or the touch-screen.

The system may include any type of electronically connected group of computers including, for instance, the following networks: Internet, Intranet, Local Area Networks (LAN) or Wide Area Networks (WAN). In addition, the connectivity to the network may be, for example, remote modem, Ethernet (IEEE 802.3), Token Ring (IEEE 802.5), Fiber Distributed Datalink Interface (FDDI) or Asynchronous Transfer Mode (ATM). Note that computing devices may be desktop, server, portable, hand-held, set-top, or any other desired type of configuration. As used herein, an Internet includes network variations such as public internet, a private internet, a secure internet, a private network, a public network, a value-added network, an intranet, and the like.

One example of a Local Area Network may be a corporate computing network, including access to the Internet, to which computers and computing devices comprising the system are connected. In one embodiment, the LAN conforms to the Transmission Control Protocol/Internet Protocol (TCP/IP) industry standard. In alternative embodiments, the LAN may conform to other network standards, including, but not limited to, the International Standards Organization's Open Systems Interconnection, IBM's SNA, Novell's Netware, and Banyan VINES.

Some embodiments of the invention relate to a system and method employing a wireless handheld terminal for management of medical care in an environment such as a hospital. The wireless terminal preferably has at least one code reader, or scanner, used to read codes corresponding to, for example, patient identification, item identification, documentation characters and phrases, commands, and instructions. The codes are preferably machine readable codes, including one and two dimensional optically readable codes such as barcodes, but can include radio frequency identification (RF ID) devices or tags. The codes can be applied to objects, cards, or placards throughout a hospital environment. In one embodiment, each user can have a card, or codesheet, comprising that user's most commonly used codes. Thereby, the user only needs to scan the codes on their codesheet to enter particular data, or carry out specific instructions.

As described below, in addition to scanning in codes as data, the system also scans in codes that provide an instruction to the system. By scanning in a plurality of codes, a user, such as a nurse, can send messages, page, print, process commands at a server, and order medical tests. For example, in one embodiment, a nurse may need to page a doctor to the patient's location. In this embodiment, the nurse would scan the patient ID bracelet, which includes a scan code sequence identifying the patient. The nurse would then scan an instruction code, printed either on a placard or in the room, which provides the instruction “page the doctor”. The scanned codes would be transmitted wirelessly to the server, and the instruction would be executed at the server.

The server would query a database or lookup table of codes and instructions for the scanned codes and determine that one of the scanned codes corresponded to a “paging” instruction. The system would then execute instructions to identify the doctor to be paged based on the scan code corresponding to the identification of the patient, and then page the appropriate doctor to the patient's location. In one embodiment, the system is linked to a hospital administration system which stores the name of each patient, and the doctor for the patient that is currently on-call. Thus, the wireless terminal not only provides the function of reading data with the code scanner, but also advantageously performs functions using the same code scanner.

The terminal preferably establishes communication with a server that maintains a database of codes and corresponding information or commands which it uses to process the codes received from the terminal via a wireless communication link. The server is preferably in communication with additional devices via a network, such as a local area network (LAN), where the additional devices perform a variety of functions, such as messaging, printing, or record keeping. The server is also configured to communicate with the wireless terminal to provide requested information or information in response to scanning of particular codes, such as codes corresponding to particular medications.

In one aspect of the invention, the wireless terminal has processing capabilities such that it can process codes locally without communicating with the server, and thereby interacting with the user autonomously in certain capacities. The terminal communicates with the user via indicators and a display screen, such as an LCD screen. The terminal can also be adapted with audio indicators such as a beep to indicate a warning condition or a message awaiting acknowledgement. The user can acknowledge or respond to messages displayed on the screen with an acknowledgement or “OK” button on the terminal. As one example, a nurse might scan in a code from a packet of Digoxin, which is a medicine to treat heart problems that should be administered only after an apical pulse measurement has been taken by the nurse. Once the nurse scans the code from the Digoxin packet, a processor in the terminal reads the code and compares it with an internal list of codes. In this case, the terminal would recognize the code as requiring an apical pulse measurement, and would display a warning and request input from the nurse of the apical pulse. The nurse could then scan in the apical pulse measurement by scanning codes corresponding to the appropriate numbers in order to enter the pulse measurement into the terminal. Once the pulse measurement was entered, the terminal could transmit the entered data to the server.

The codes used and maintained in the system are preferably in a “closed” symbology, such that only one code corresponds to a particular instruction or piece of information. This ensures that the system does not receive duplicate codes which correspond to different instructions or information. In certain embodiments, the codes are implemented as a 2-D matrix, or DOT as described in International Publication No. WO 02/07065, hereby incorporated by reference in its entirety. In one embodiment, the physical DOT is 7 mm in diameter, and comprises 321 white or dark hexagons. In another embodiment, the physical DOT is approximately 5 mm in diameter, but less than 7 mm in diameter. In one embodiment, a computer server can be configured to generate a 64 bit number, encrypt it, and algorithmically produce a 2-D DOT which uniquely represents the encoded data. Where the system is implemented using the DOT symbology, the system can have additional capabilities such as the methods and systems described in International Publication No. WO 02/21794 A2. As used herein, a “dot scanner” is configured to read the DOT symbology.

The 2-D DOT advantageously permits high density placement of DOTS as explained in Publication No. 02/21794 A2. The DOTS can be placed adjacent to one another in the same horizontal row or vertical column without the data from one DOT interfering with the ability of a terminal to read an adjacent DOT. Thus, the DOTS can be arranged as an array of DOTS. In one embodiment, a center to center distance between adjacent DOTS is approximately 20 mm and is less than 25 mm. In other embodiments, the center to center distance between adjacent DOTS is less than about 10 mm, 15 mm, 20 mm, 30 mm, 35 mm, 40 mm, 45 mm, 50 mm, 55 mm, 60 mm, 65 mm, 70 mm, 75 mm, 80 mm, 90 mm, or 100 mm.

Due to the vast number of data combinations made possible by the DOT symbology, (18 billion billion), an entire medical management system can be implemented using DOT's to represent all of the information and commands desired in the system. Thereby, the possibility of confusion with commonly used barcodes is eliminated. The system may, however, be implemented with both DOT and barcode technology, where the terminal would include both a barcode scanner and a DOT scanner. Such an embodiment is described below.

In certain embodiments, the authentication codes are implemented as the 2-D matrix, or DOT, and the code reader is implemented as an optical scanner configured to read information encoded in the DOT, as described in International Publication No. WO 02/07065. Additional aspects and functions can be added to the secure system implementing the DOT authentication code and optical scanner, such as those described in International Publication No. WO 02/21794, hereby incorporated by reference in its entirety.

In one embodiment, the DOT is 7 mm in diameter, and comprises 321 white or dark hexagons. The DOT contains 120 bits of Reed-Solomon forward error correction, 32 bits of server routing code, and 128 bits of net data space which provides for 10³⁸ data combinations that can be encrypted. Thus, the DOT can encode a 14 digit GTIN (Global Trade Identification Number) conforming to EAN.UCC format and a 24 digit serial number which can be unique as a fingerprint. The DOT can be printed using current printing technology and conventional inks, print media, and printers, such as thermal and laser printers, and the DOT scanner uses a low cost scan engine and secure link for communication with the system server/database.

The large number of unique data combinations available using the DOT and the small size of the DOT, make it ideal for use in the pharmaceutical tracking system described herein. In contrast to barcodes, the DOT can be applied to individual dosage packaging without the use of excess packaging to provide enough space for the code. Because of the extensive number of data combinations and corresponding codes that can be encrypted in a single DOT, a different DOT can be applied to each unit at the smallest packaging level without running out of unique data combinations or codes. Thereby, the smallest packaging level of a pharmaceutical product, such as individual or single dose packaging, can be authenticated and tracked from the point of manufacture to actual administration or use of the product.

### System Overview

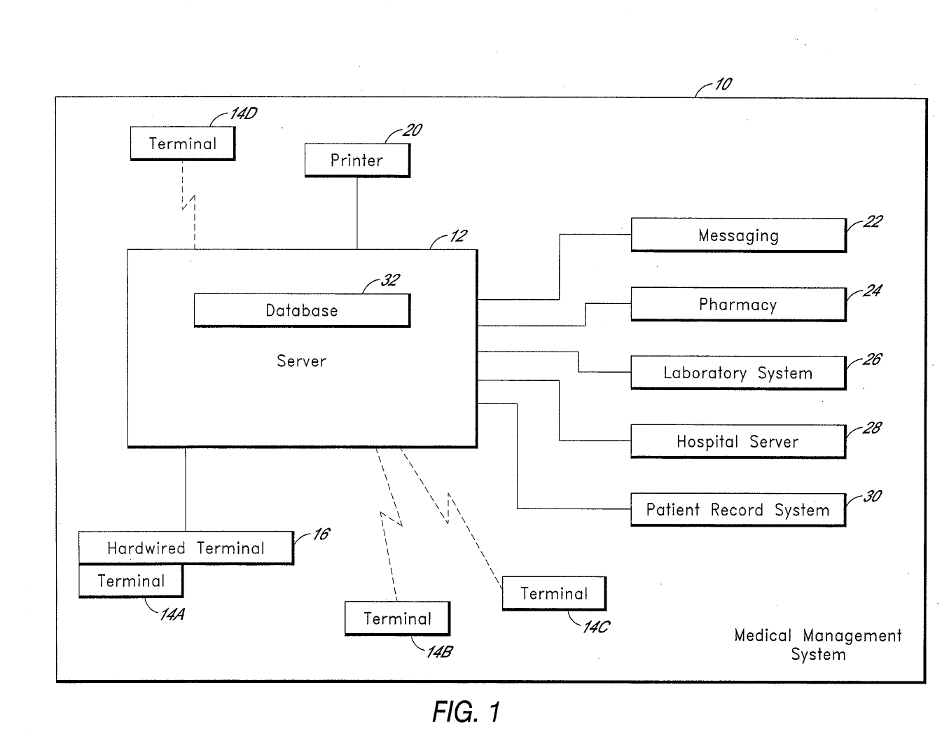

FIG. 1 is a block diagram of one embodiment of a medical management system 10 implemented in a hospital environment. The system comprises a server 12, and a plurality of battery powered terminals 14A-D, wherein the wireless terminals 14B-14D and server 12 communicate according to IEEE 802.11 wireless LAN specifications. The system can also use other wireless communications specifications known in the technology, such as COMA, TOMA, AMPs or Bluetooth. The system also includes a hardwired terminal 16 coupled to the server 12 via a network or direct connection, wherein the hardwired terminal 16 can be used as a control point for the system such that only authorized users can activate a terminal 14A, and as a hardwired communication link between a terminal 14A and the server 12.

The terminals 14A-14D and server 12 communicate periodically during communication sessions and are not required to be constant communication. Thereby, battery power at the terminals 14A-14D can be conserved and situations where the terminals 14A-14D are out of communication range with the server 12 do not create power consuming loop processes wherein the terminals 14A-14D continually attempt communication with the server 12. The server 12 and terminals 14A-14D, however, can communicate upon user request and are not limited to communication during the designated communication sessions. The terminals 14A-14D are preferably small in size for ease of portability and one-handed use.

The server 12 is also coupled to a plurality of peripheral devices and systems, such as a printer 20, a messaging system 22, a pharmacy system 24, a laboratory system 26, a hospital server 28, and a patient record system 30, via a network connection. Commands or instructions received from the terminals 14A-14D are communicated by the server 12 to the various devices and systems for performance of requested tasks, and information from the various peripheral devices and systems are communicated to the terminals 14A-14D by the server 12. For example, the pharmacy system 24 can send updated medication information for patients or send notification to the server 12 when a patient's medication is ready. The terminals 14A-14D can also query the pharmacy system 24 for information via the server 12. Similarly, the terminals 14A-14D can send laboratory test requests to the laboratory system 26, or receive test results from the laboratory system 26 via the server 12.

Where the hospital server 28 maintains, for example, patient registration information, the hospital server 28 can send updated information to the server 12, and The terminals 14A-14D can update the hospital server 28, for example, when a patient has been discharged.

In one embodiment, the patient record system 30 is an Electronic Medical Record (EMR) system, and is updated with information from the wireless terminals 14 so as to maintain an electronic record of each patient's medication administration and any additional comments input to the terminals 14A-14D by a user.

Thus, the terminals 14A-14D have capabilities similar to computer terminals which are connected to the peripheral devices and systems through a conventional network. The interaction of the terminals 14A-14D, server 12, and peripheral devices and systems will be described in further detail hereinafter.

The server 12 comprises a database 32 for storing a plurality of scan codes and each codes' corresponding data or instruction in order to perform a plurality of electronic tasks. The data includes, for example, information corresponding to a patient, medication, objects, and note taking entries, and the instructions can include tasks such as “print a patient report”, “order laboratory tests”, and “request assistance”. The database 32 can be modified and maintained using the terminal 16 or additional computer terminals in communication with the server 12. In certain embodiments, the system comprises both a local server and a remote server, including local and remote databases. In such embodiments, the local databases provide pointers to locate the appropriate remote server. In addition, where a plurality of servers and databases are used in a single hospital, for example, a master computer or server can be used to maintain and update the databases.

### Server

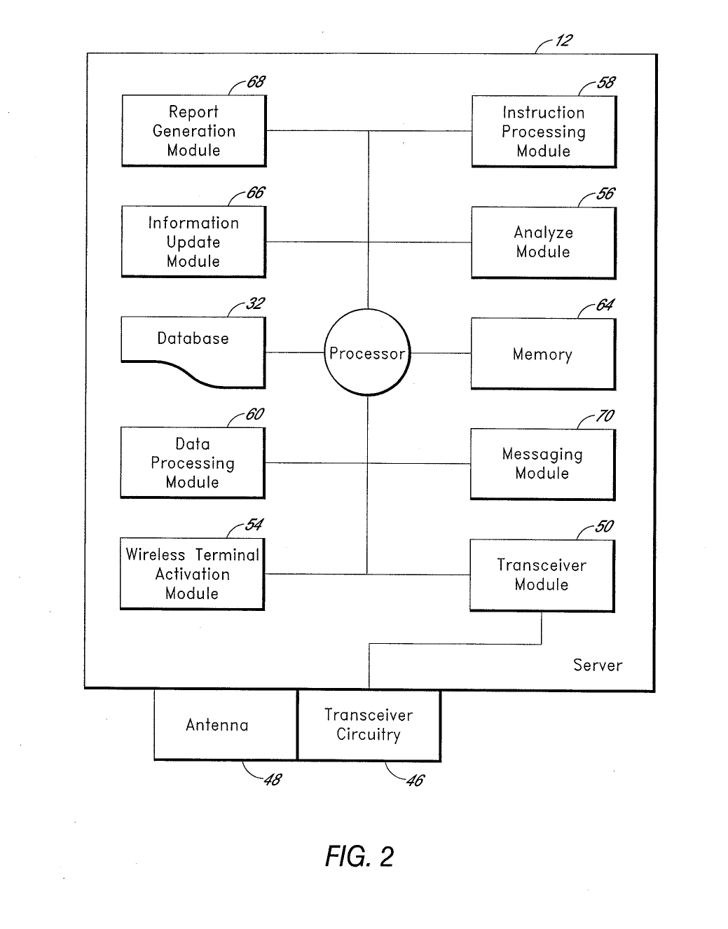

FIG. 2 is a block diagram of one embodiment of the server 12, wherein the server 12 is in data communication with transmit and receive, or transceiver circuitry 46 including an antenna 48 for wireless communication with the plurality of wireless terminals 14B-14D. The server 12 may include additional transmit and receive circuitry for processing of data and instructions where the server 12 is linked to a wireless access point including a transceiver and antenna. As described above, the server 12 can also communicate with the wireless terminals 14B-14D via a hardwired connection at the hardwired terminal.

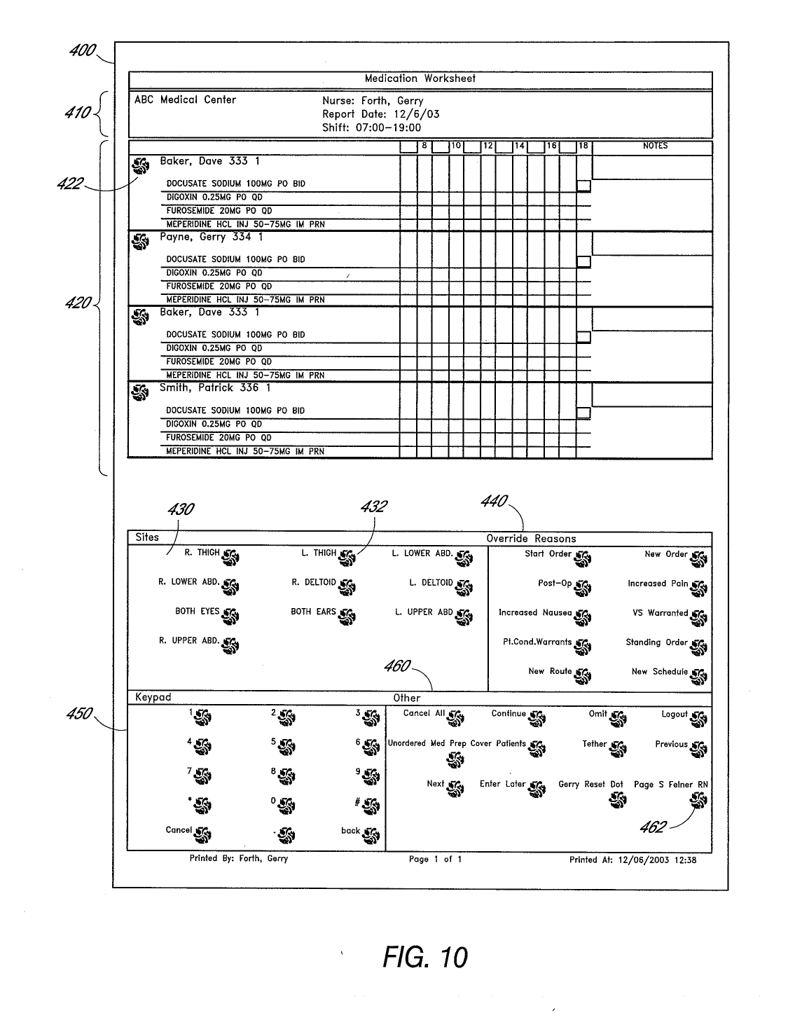

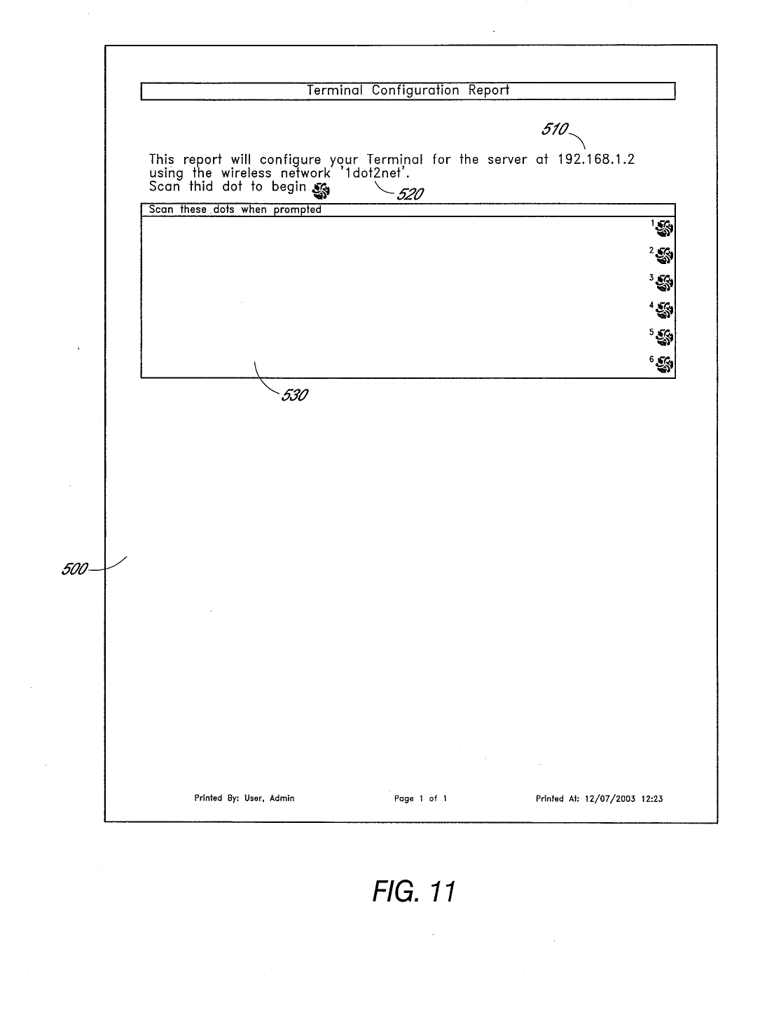

The server 12 comprises a transceiver module 50 configured to receive and facilitate transmission of data via the transceiver circuitry 46. The server 12 further comprises an activation module 54 configured to initiate each terminal 14 at the beginning of each use. In one embodiment, a user may request activation of a terminal 14 by scanning a code (or codes) corresponding to user information, such as a username and password. In one embodiment, the user scans an identification code on their name badge, and thereafter enters a password into the code scanner. In response to an activation request, the activation module 54 first verifies whether the user is authorized to use the terminals 14A-14D by attempting to correlate the user information with information stored at the database 32. Secondly, where a nurse at a nurse's station in a hospital is requesting activation of the terminals 14A-14D, the activation module 54 sends a list of tasks to be performed and information to be used by the nurse during their working shift. More specifically, where Nurse A requests activation of a terminal, e.g. terminal 14B, the activation module 54 sends information corresponding to Patients A, B, C, and D, who are assigned to Nurse A, to the terminal 14B along with any additional tasks to be performed by Nurse A for those patients or in general. These exemplary features of the system 10 are discussed in more detail hereinafter below in reference to FIGS. 10-11.

As shown in FIG. 2, the server 12 also comprises an analyze module 56 in data communication with the transceiver module 50 and configured to analyze incoming data or instructions from the wireless terminals 14 via the transceiver circuitry 46. The analyze module 56 is in data communication with additional processing and task performance modules at the server 12, and communicates the incoming data or instruction to the appropriate module according to its analysis. As will be appreciated by those skilled in the art, the server may include a separate analyze module or plurality of modules for analysis of data or instructions from the peripheral devices and systems and for analysis of data and instructions from the wireless terminals 14B-14D.

The server 12 further comprises an instruction processing module 58 for processing an instruction, and a data processing module 60 for processing data, wherein analysis by the analyze module 56 determines whether a communication from a wireless terminal comprises data or an instruction, and sends the communication contents to the appropriate module for processing. The server 12 also includes a processor 62 and a memory 64, used by instruction processing and data processing modules 58, 60 during operation. The memory 64 can also be configured to store the database 32 of scan codes and corresponding instructions or data. It should be realized that additional memory types, such as a flash memory, can also be used to store data within the server 12.

The memory 64 is also configured to store information received from the peripheral systems for use by the wireless terminals 14B-14D and their users. For example, where a server 12 is assigned to each nursing station in a hospital, the memory 64 stores information corresponding to the patients assigned to the nursing station and the tasks to be performed by the caregivers assigned to the patients. More specifically, the medications, time of administration, and any additional information regarding the care of patient A is stored in memory 64 for use by the caregiver assigned to patient A.

The additional processing and task performance modules at the server 12 comprise an information update module 66, configured to update information stored in memory 64 with information from the plurality of peripheral devices and systems. For example, the information update module 66 receives medication orders from the pharmacy system, updates the memory 64 with the pharmacy orders, and sends updated medication orders to the appropriate wireless terminal 14.

As shown in FIG. 2, the server 12 further comprises a report generation module 68 configured to coordinate generation of a report for a particular patient or for all patients assigned to the user of a terminal, e.g. terminal 14B in response to an appropriate scan code instruction from a terminal 14B. The report generation module 68 receives a report generation instruction from the instruction processing module 58, and uses the processor 62 and memory 64 to obtain the information to be included in the report. Once the information has been gathered, the report generation module 68 sends the report to the printer. This allows a user to scan a particular code on the terminal in order to have a predefined report printed from the data stored on the server or elsewhere.

In one embodiment, the server 12 also includes a messaging module 70 configured to receive, generate, and send messages to the wireless terminals 14 and peripheral systems. The module 70 receives messages from the messaging system 22 (FIG. 1) to be sent to the wireless terminals 14B-14D. The messaging system 22 can include a computer terminal, or plurality of terminals, where a user can enter a text message to be sent to a particular wireless terminal 14B-14D by designating the user by name. For example, a text message comprising notification of an urgent telephone call can be entered at the hardwired terminal 16 for Nurse A. The messaging system 22 communicates the message and corresponding terminal user identification (“Nurse A”, for example) to the server 12. The server 12 routes the message and user identification to the messaging module 70, which looks up the user identification (Nurse A) in the database 32 or memory 64 to determine which terminal 14B-14D should receive the message. The messaging module 70 then formats the message for the destination terminal 14B-14D and sends the message via the transceiver module 50 and transceiver circuitry 46 to the terminal controlled by Nurse A.

In one embodiment, the report generation module 68 is configured to generate a message to notify the user of the terminal, e.g. 14B that requested generation of a report that the report has been printed. The generated message is communicated to the messaging module 70, which formats the message and adds information for communication to the appropriate terminal 14B.

In another embodiment, the patient record system 30 maintains an electronic record for each patient with respect to medication administration, including, but not limited to, type of medication, quantity of medication administered, how administered, and time of administration. This information may then be stored at the server 12 and terminal 14B, such that the server 12 may generate an alert or notification message if a terminal fails to timely send data indicating administration of medication. Alternately, the terminal may generate an alert or notification message if expected medication administration is not received by the stored time of administration, or within a predefined time period prior to the specified time of administration.

For example, a patient may be scheduled for administration of a particular medication at a predetermined time. The terminal 14B tracks an elapsed time after a predetermined medication administration time and may generate an alert or notification message if no indication of medication administration has been received within a predetermined alert time. The predetermined alert time may be, for example, 30 minutes or one hour after a scheduled administration time. Thus, the terminal 14B may be configured to monitor for an event where the time elapsed since the scheduled time exceeds some predetermined latency time. The terminal 14B may transmit the message to the server 12 for entry into the patient's care record. The terminal 14B will continue to periodically alert the user of the terminal 14B until the user acknowledges the alerts or the expected information is entered at the terminal 14B. The user of the terminal 14B may acknowledge the alert or notification by, for example, selecting the “OK” button on the terminal 14B.

Alternatively, the server 12 may send a message to a terminal 14B in response to some predetermined patient event. For example, a patient may have had one or more lab tests ordered to evaluate a condition. The server 12 may send a message to a terminal 14B in response to events such as availability of lab results for a particular patient, changes in patient medication, changes in patient health which may be monitored manually or through the use of telemetry, or some other predetermined event, such as a critical abnormal lab result.

In one embodiment, the server 12 maintains statistics on usage related to each individual terminal 14B, the user, time information, and the type of code (barcode or DOT, for example) read by the user during each code read or scan event. In addition, information regarding, for example, mistakes in medication administration or user operation of the terminal, misreads of the code scanners, or other operational activity outside of an ideal work flow is tracked by the server. Such tracking or compilation of statistics provides for future performance improvement and optimization of the system.

### Terminal

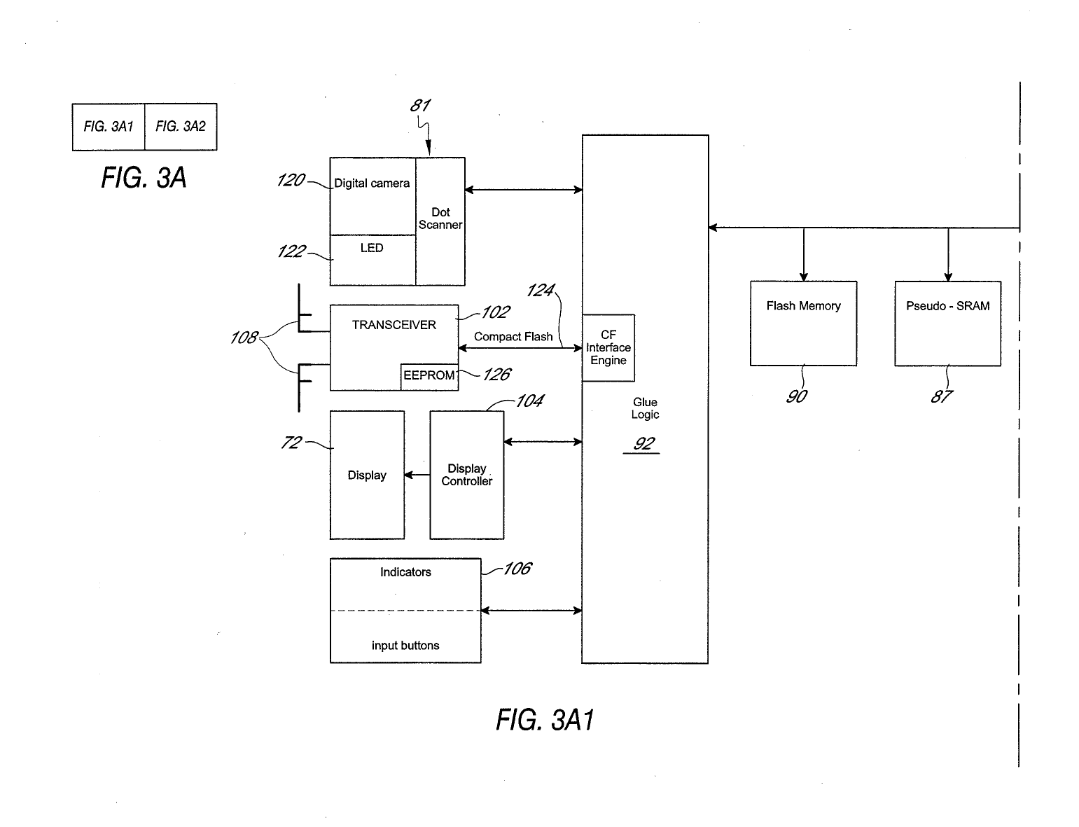

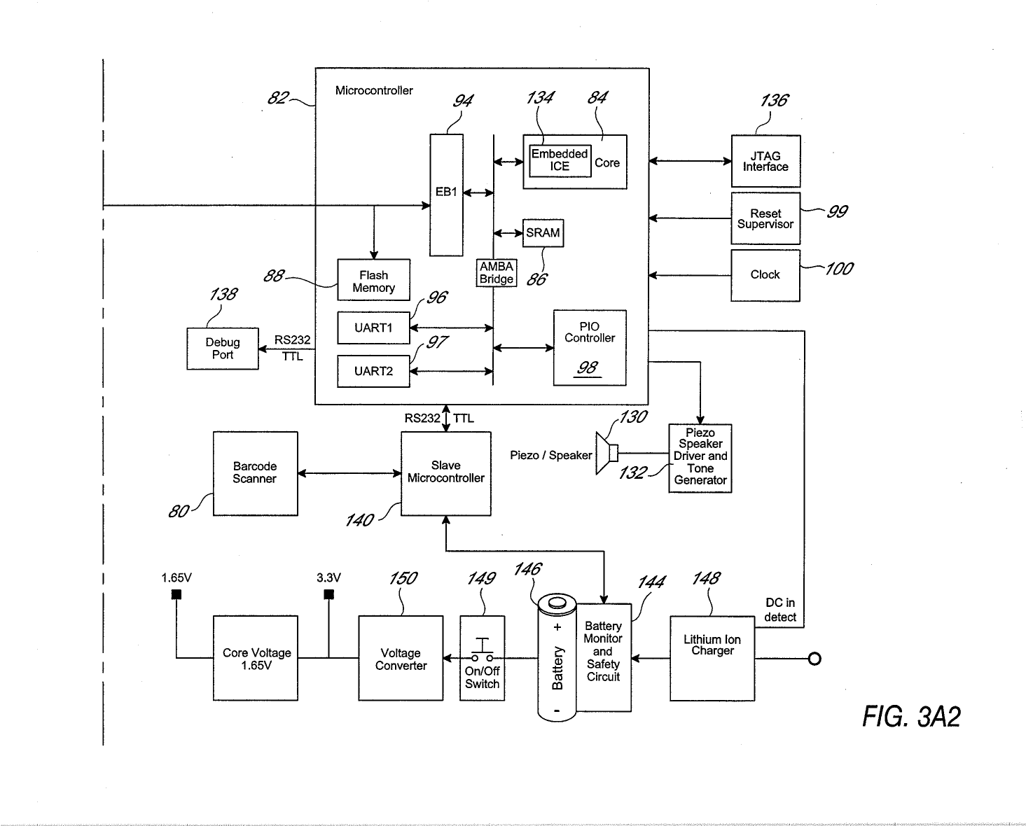

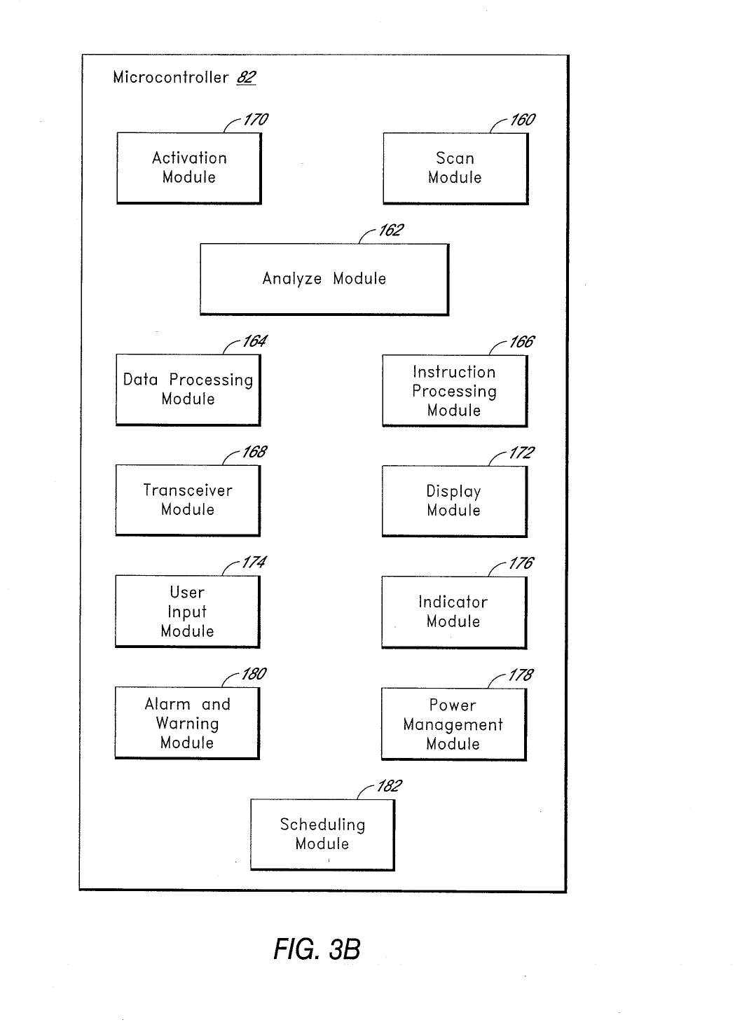

FIG. 3A is a block diagram of one embodiment of a terminal, e.g. terminal 14B. As shown, the terminal 14B comprises the barcode scanner 80, DOT scanner 81, display 72, LED indicator 74, DOT scan button 76, barcode scan button 77, and acknowledge button 78. The terminal 14B further comprises a microcontroller 82, such as an Atmel AT91 16/32-bit microcontroller, which includes a processor 84. In one embodiment, the processor 84 has a 32-bit reduced instruction set computer (RISC) architecture with a 16-bit instruction set, for example, and is configured for low power consumption.

The microcontroller 82 further comprises memory, which may be a combination of a static random access memory (SRAM) 86 and flash memory 88. The SRAM 86 is configured to store program and application data, and preferably has a size capable of supporting a real-time operating system and application data, as well as memory space for image processing using data from the DOT scanner. In one embodiment, the SRAM 86 is supplemented by a pseudo SRAM device 87, which combines a dynamic random access memory (DRAM) cell structure with an SRAM interface, so as to provide for low power consumption and low device cost. As will be appreciated by those skilled in the art, the single communication lines connecting elements of the terminal 14 are exemplary in nature, and a plurality of communication or control lines are contemplated.

The flash memory 88 is configured for permanent storage of boot firmware, operating system, driver, protocol stack, and application programming, and is also preferably configured for low power operation. In one embodiment, the flash memory 88 provides a relatively small storage amount, such as 2 Mbytes, and additional flash memory 90 is provided external to the microcontroller 82. For example, an additional 4 or 8 Mbytes of flash memory 90 is mapped into the memory area of the microcontroller 82 using external interface or glue logic 92 for address decoding into the same bank as the flash memory 88. In one embodiment, the terminal operating system and/or application software at the flash memory 88, 90 can be upgraded in whole or in part via a wireless communication link.

The microcontroller 82 also comprises a plurality of interfaces for communication with a plurality of peripheral devices. In one embodiment, the microcontroller 82 further comprises an external bus interface 94 configured to interface with the external memory components 87, 90 and glue logic 92, for example. The microcontroller 82 may also comprise a plurality of universal asynchronous receiver-transmitters (UART's) 96, 97 configured for asynchronous communications with peripheral devices, a plurality of programmed input/output lines, and a programmed input/output controller 98, configured to control the signals on the parallel input/output lines according to information from the processor 84.

The terminal, e.g. terminal 14B may additionally comprise a supervisory chip 99 coupled to the processor 84 and including a reset function and a watchdog timer. The reset function facilitates a system reset, for example, when the voltage supply rail exceeds a predefined threshold and maintains the reset condition for a predefined period of time while the terminal 14B components are allowed to stabilize. The watchdog timer is coupled to a watchdog timer signal output from the processor 84, wherein the timer will trip in the event of a software deadlock at the processor 84, and subsequently initiate a system reset. In one embodiment, the terminal 14B includes a clock 100 which provides the CPU clock, and the processor 84 can be configured to reduce the clock rate to conserve power when in a standby or sleep mode. The clock 100 may include a clock synthesizer. The microprocessor 82 may also use the clock as a real-time clock in order to communicate reminder messages or tones to the user for scheduled medication administrations or tasks. The clock can also provide for time stamping of each code scanning event or other events at the terminal 14B. The terminal 14B may also include a real time clock, such as the Real Time Clock chip DS2415 from Maxim Semiconductor (Dallas), to provide the microcontroller 82 with real time information.

The glue logic 92 is preferably provided by a low power complex programmable logic device (CPLD), and is configured to interface with the DOT scanner 81, a wireless communication transceiver 102, a display controller 104, and a user input and indicator controller 106. The terminal 14B may further include one or more antennas 108, coupled to the wireless communication transceiver 102. The DOT scanner 81 comprises an image sensor 120, such as an Omnivision OV6130 CMOS black and white imager incorporated into a digital camera including lens optics, and a bright LED 122 for illumination of the DOT image for scanning. In one embodiment, the DOT scanner 81 is a complete, individual unit and is configured to interface with the microcontroller 82 via the glue logic 92.

The wireless communication transceiver 102 is configured to communicate with the server 12 using wireless communication specifications such as CDMA, TDMA, AMPs, RF, Bluetooth, or a WLAN specification, and the one or more antennas 108. In one embodiment, the wireless communication transceiver 102 is a wireless LAN (WLAN) module comprising a media access controller (MAC), such as the Agere WaveLAN WL 60010 MAC, and physical layer solution, such as the Agere WaveLAN WL 1141 802.11b Physical Layer Solution. The MAC controller interfaces with the glue logic 92 via a compact flash interface 124, and implements the 802.11 protocol specified by IEEE standards. The WLAN module may also be configured to implement an advanced encryption standard (AES). In one embodiment, the terminal 14B further comprises an EEPROM 126, which is coupled to the transceiver 102 and configured to store device information, such as production attributes (serial number, board version, manufacturing date, MAC address, production number, etc.) and radio calibration data.

The display controller 104 is configured to interface with the display 72, which can be implemented with a black and white back-lit LCD. For example, the display 72 can be a 128×64 dot LCD module with chip-on-glass (COG) technology, or a 122×32 dot LCD module with tape carrier package (TCP) technology. The graphic controller 104 can be implemented, for example, with the Samsung Graphic Driver (KS0713/S6B1713). In one embodiment, the display controller 104 is not configured with built-in character fonts and a character font table is stored in memory in the terminal, e.g. terminal 14B. The display controller 104 may be configured to display predefined symbols, such as a battery power indicator, battery charge status indicator, wireless communication status, and wireless communication signal strength.

In one embodiment, the user input and indicator controller 106 is configured to interface with one or more visual indicators, such as a plurality of single color LED's, bicolor LED's, or the tricolor LED indicator 74, so as to facilitate activation or illumination of such indicators according to control signals from the microcontroller 82. The user input and indicator controller 106 is further configured to monitor and receive input from one or more input switches or buttons, such as the DOT scan button 76, the barcode scan button 77, and the acknowledge or “OK” button 78. In one embodiment, the terminal, e.g. terminal 14B includes a jog dial switch to select and initiate the reading of a barcode or DOT image. The user input and indicator controller 106 preferably interfaces with the microcontroller 82 via the glue logic 92, wherein the glue logic 92 extends general purpose input/output (GPIO) capabilities from the microcontroller 82. In addition, a de-bounce function may be provided for the input buttons and the jog dial switch.

In one embodiment, the terminal, e.g. terminal 14B comprises one or more audio indicators, such as a piezo speaker 130 and driver 132, coupled either directly to the microcontroller 82 or through the glue logic 92. The audio indicator preferably provides acknowledgement to a user of a successful code reading and/or decoding of a barcode or DOT image, and may also notify a user of a waiting message, alarm, or warning. The audio indicator may also produce different audio signals to indicate different conditions to the user, such as a first audio signal to indicate a successful code reading and decoding, and a second, different audio signal to indicate an unsuccessful code reading and/or decoding.

The microcontroller 82 may include testing circuitry or one or more interfaces for testing circuitry at the terminal 14B. In one embodiment, the microcontroller 82 comprises an embedded in-circuit emulator 134, and the terminal includes a joint test action group (JTAG) interface 136 to support ARM standard embedded in-circuit emulation. The terminal 14 may further comprise a debug port 138 for the microcontroller 82, comprising an RS232 transistor-transistor logic (TTL) interface to communicate with a peripheral test and debug monitor or circuit. The debug port 138 may also provide for initial programming of flash memory in the terminal 14B through a built-in flash programming routine at the microcontroller 82.

The terminal 14B further comprises the barcode reader 80, which may be implemented with a modular barcode scan engine such as a miniaturized, high performance 650 nm laser-based, single-line decoded scan engine from Symbol Technologies (model no. SE-923). The scan engine is preferably modular and self-contained, and includes a microcontroller configured to decode a barcode into a format compatible with and readable by the microcontroller 82. In one embodiment, the barcode reader 80 communicates with the microcontroller 82 through an RS232 TTL interface via a slave microcontroller 140. The slave microcontroller 140 is preferably configured for low-power operation, and acts as a pass-through device when the barcode reader 80 is configured to decode barcode data independently. In certain embodiments, the barcode reader 80 is implemented with a scan engine which is not configured to decode a barcode, and the terminal 14B further comprises additional decoding or conversion circuitry configured to convert barcode data into an acceptable format for processing at the slave microcontroller 140.

In one embodiment, the terminal, e.g. terminal 14B comprises a battery monitor and safety circuit 144 coupled to a battery power interface 146. The battery power interface 146 is preferably configured to draw power from a re-chargeable battery, such as a Li-Ion Polymer single cell battery, which provides approximately 3.7 volts. In one embodiment, the battery and the battery monitor and safety circuit 144 are a single unit, and may include the Texas Instruments chip BQ2050, for example. Where a re-chargeable battery is used, the terminal 14B further comprises a battery charger interface 148 configured to interface the battery monitor and safety circuit 144 with an external battery charger through metallic charger contacts, for example. The battery charger interface may be implemented, for example, with the Texas Instruments lithium ion charger, part no. BQ24002PWP.

The battery monitor and safety circuit 144 is configured to monitor the power level in the battery and conditions during charging, and the slave microcontroller 140 provides an interface, preferably a one wire interface, between the microcontroller 82 and the battery monitor and safety circuit 144. The battery preferably provides 3.3 volts for input/output and 1.65 volts for the processor core power rails through an on/off switch 149 for operation of the terminal 14B. In one embodiment, the terminal 14B includes one or more voltage converters 150, such as the Micropower Synchronous Buck-Boost DC/DC converter by Linear Technology (LT3440EMS), to provide the desired power rails.

As the terminal 14B preferably remains operational for an extended period of time, such as up to 12 hours, the terminal 14B is configured for low power operation. In one embodiment, peripheral components of the reader are not all operated simultaneously. For example, the terminal e.g. terminal 14B is preferably configured to refrain from transmitting and receiving data at the wireless communication transceiver 102 at the same time a code reading event occurs at the DOT reader 81 or the barcode reader 80. In certain embodiments, the wireless communication transceiver 102 may consume a large amount of power, and the specific transceiver implemented, such as the Agere WaveLAN, provides a variety of power savings modes that can be implemented to optimize the operational time of the terminal 14 between battery re-charging events.

FIG. 3B is a block diagram illustrating one embodiment of a plurality of modules for implementation at the microcontroller 82. As will be appreciated by one skilled in the art, the following described modules may be implemented in conjunction with processors and storage devices in addition to or in place of the microcontroller 82. As illustrated in FIG. 3B, the microcontroller 82 comprises a scan module 160 configured to process the codes read by the code scanners 80, 81, and an analyze module 162, configured to analyze the processed scan codes. The analyze module 162 is configured to determine, for example, whether a scan code corresponds to data or an instruction. If the analyze module 162 determines that a scan code corresponds to data, the data scan code is processed at a data processing module 164. If the analyze module 162 determines that a scan code corresponds to an instruction, then the instruction scan code is processed at an instruction processing module 166.

The data or instructions corresponding to the scan codes may be used or performed locally at the terminal, e.g. terminal 14B, or transmitted to the server 12 via the communication transceiver 102. The microcontroller 82 may include a transceiver module 168, which is configured to format data or an instruction for communication to the server according to the communication specifications of the communication transceiver 102. As discussed above, the terminal preferably communicates with the server 12 during designated communication sessions. During a communication session, the terminal 14B preferably transmits more than a single scan code from the terminal 14, however, the terminal 14B can transmit a scan code outside a designated communication session according to whether the data or instruction is to be sent to the server immediately. Determination of whether data or instructions are to be transmitted immediately may be based on user input or the type of data or instruction.

The microcontroller 82 also comprises an activation module 170 configured to operate in conjunction with the activation module 54 at the server 12 when a user requests activation of a terminal, e.g. terminal 14B. Following user authorization by the server 12, the activation module 170 is configured to process information sent by the activation module 54 at the server 12 and store the information in memory. In association with the modules illustrated in FIG. 3B, memory will be referred to generally and may include, but is not limited to, the SRAM 86 and Flash memory 88 at the microcontroller 82, and the additional pseudo SRAM 87 and Flash memory 90.

Referring to the example previously discussed, Nurse A requests activation of the terminal 14B by scanning a code on her identification badge. Upon authorization of Nurse A to use the terminal 14B, which may also include input of a password at the hardwired terminal 16 or the terminal 14B, the activation module 170 coordinates receipt of information corresponding to Patients A, B, C, and D, who are assigned to Nurse A, along with any additional tasks to be performed by Nurse A for those patients or in general. The activation module 170 then stores the received information in memory. The activation module 170 also stores the authorized user's identification code in memory, such that data and instructions sent to the server 12 can be tagged with the user's identification for future use, for example, in record keeping. In one embodiment, the terminal 14B communicates with the server 12 using a hardwired connection during an activation procedure.

The microcontroller 82 further comprises a display module 172 configured to facilitate display of messages, text, and indicators on the display 72 via the display controller 104. The microcontroller 82 also comprises a user input module 174, configured to monitor and process user input received at the OK button 78 and a keypad if included on the terminal 14B. The user input module 174 responds to the received input accordingly, for example, depending on the message being displayed on the display 72.

The microcontroller 82 may further comprise an indicator module 176 configured to control illumination of the Good Read and message indicator 74, via the user input and indicator controller 106. As discussed above, the indicators may include an LED configured for illumination, for example, to notify a user that the terminal 14B is awaiting acknowledgment of a message or has displayed a warning at the display 72. The indicator module 176 may also be configured to facilitate illumination of the Good Read indicator 74 when either of the scanners 80, 81 have scanned a new code. Where the terminal 14 includes an auditory indicator, the indicator module 176 is further configured to facilitate activation of the auditory indicator, such as a beep or buzz, as a warning or to indicate that a code has been properly or improperly read by one of the scanners 80, 81. The terminal 14B can include a plurality of auditory indicators, which can be downloaded, for example, from the server 12 via a hardwired or wireless connection.

The microcontroller 82 also includes a power management module 178 configured to monitor remaining battery power via the battery monitor and safety circuit, and to schedule low power or no power operation of terminal components to conserve power. The power management module 178 may also be configured to facilitate display of the amount of available power or status of the battery via an indicator as discussed above. The power management module 78 may be further configured to facilitate communication of this information to the server 12. In one embodiment, the microcontroller 82 further comprises an alarm and warning module 180, configured to detect alarm and warning conditions and generate alarm or warning messages for display at the display 72, or activation of the indicators.

In the terminal based embodiment of the alert system described above, the terminal can further be configured maintain an electronic record for each patient with respect to medication administration, including, but not limited to, type of medication, quantity of medication administered, how administered, and time of administration. The microcontroller 82 may generate an alert or notification message if a user of the terminal fails to timely indicate administration of medication. A user of the terminal may timely indicate administration of medication by, for example, reading the DOTs associated with the patient and the medication. The microcontroller 82 may include a scheduling module 182 configured to manage scheduled tasks such as medication administration times, to monitor user input indicating completion of scheduled tasks or rescheduling thereof, and user notification of scheduled tasks.

For example, a patient may be scheduled for administration of a particular medication at a predetermined time. The terminal uses a schedule monitoring function at the scheduling module 182 to track an elapsed time after a predetermined medication administration time and may generate an alert or notification message if no indication of medication administration has occurred within a predetermined alert time. As with the server based system, the predetermined alert time may be, for example, 30 minutes or one hour after a scheduled administration time. Thus, the scheduling module 182 may monitor data entry for receipt of scan codes indicating administration of a medication or completion of a task, for example, which correspond to scheduled medication administrations or tasks. In the event the scheduling module 182 determines that the elapsed time following a scheduled medication administration exceeds some predetermined latency time, and no scan codes have been received to indicate completion of the scheduled medication administration, the scheduling module 182 facilitates activation of an indicator or display of an appropriate message at the display 72. The terminal may continue to periodically display or sound the notification or alert until acknowledgement by the user of the terminal. The user of the terminal may acknowledge the alert or notification by, for example, selecting the “OK” button 78 on the terminal 14 or by performing the process associated with the alert. The terminal may present the alert on a display, using one or more indicators, audibly, or using some other way or some other combination of ways.

In one embodiment, the terminal, e.g. terminal 14B is configured to schedule notification for a follow-up task in response to an event such as administration of a medication or treatment. For example, in response to receipt of user input indicating administration of a medication, the scheduling module 182 schedules a follow-up visit notification or reminder for the user to visit the patient and perform an additional task. In one particular example, a nurse may administer a pain medication and input corresponding information into the terminal 14B. In response to receipt of information regarding the administration of the pain medication, the scheduling module 182 schedules a notification for a predetermined time following administration of the medication, such as one hour. In addition, the notification may include instructions to perform an additional task or enter additional information, such as patient heart rate or a pain score provided by the patient. Subsequently, the terminal 14B notifies the user, upon lapse of the predetermined time, with instructions to visit the patient and perform a predetermined task or obtain and input predetermined information or data, such as a pain score.

### Processes

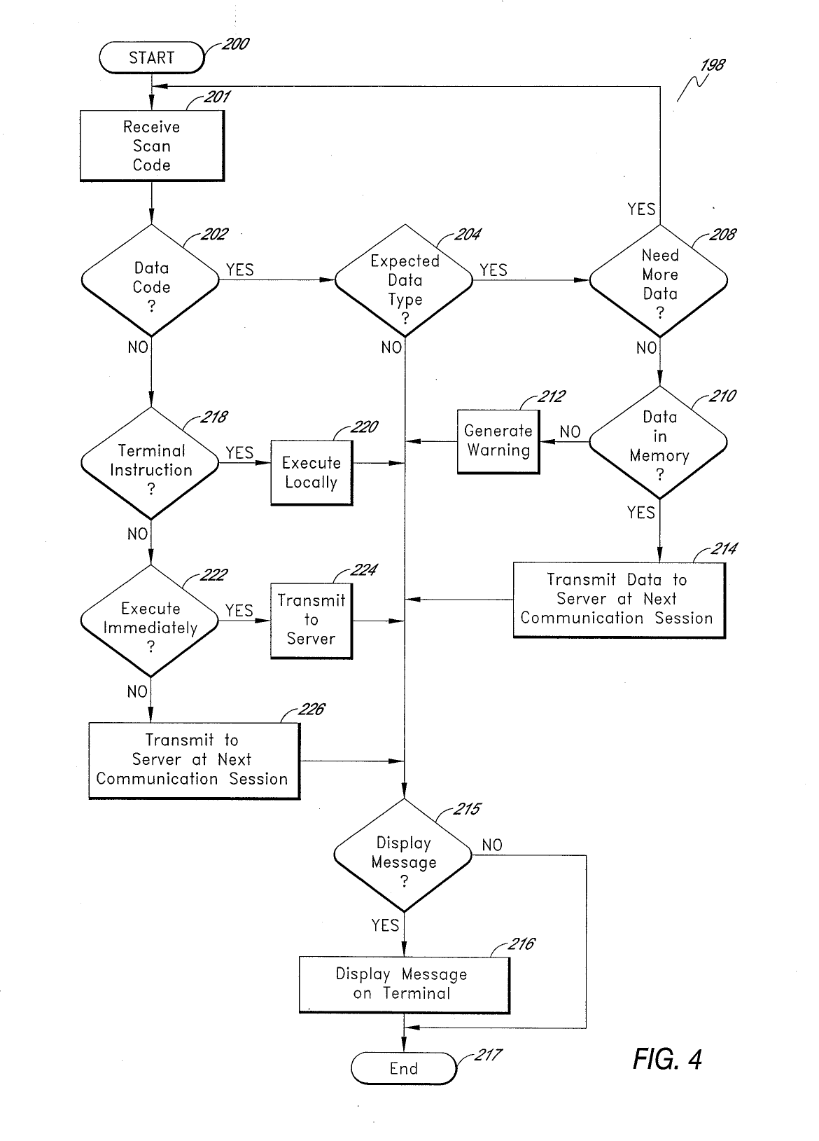

One embodiment of a method 198 of operating the terminal 14 is illustrated in the flowchart of FIG. 4. The process begins at a start state 200, and then moves to a state 201 wherein the terminal 14 receives a scan code using one of the scanners 80, 81. In a state 202, the terminal 14 determines whether the scan code corresponds to data or an instruction, wherein such a determination can be made according to a single bit in the scanned code, for example. If the terminal 14 determines that the scan code corresponds to data in state 202, the terminal 14 determines whether the data is the type of data expected in a state 204. For example, where the previous code scanned by the terminal 14 corresponds to a patient and the terminal was awaiting a scan code corresponding to a medication or note taking entry for the patient, the wireless terminal would recognize that the current scan code corresponding to a different patient was not expected.

If the scan code is determined to correspond to an expected type of data as determined in state 204, the terminal 14 determines whether to wait for additional data in a decision state 208. If the terminal 14 determines that it should wait for additional data in state 208, the wireless terminal waits to receive another scan code in state 201. For example, where a scan code corresponding to patient identification data was received in state 200, the terminal 14 would await additional data for the patient, such as the medication administered, dosage of medication, and note taking entries.

In the event the terminal 14 determines in decision state 208 that it should not wait for additional data, it proceeds to a state 210 to determine whether the scan code data corresponds to data stored in memory. For example, where the authorized medications for Patient A are stored in memory, the terminal 14 determines whether the scan code data corresponds to an approved medication for a designated patient as stored in memory. If the scan code data does not correspond to the data in memory, the terminal 14 generates a warning to the user in a state 212, indicating that a code corresponding to an incorrect medication has been scanned. The terminal 14 waits to receive another scan code in state 201. The process 198 then moves to decision state 215 to determine whether or not to display the warning to the user. If a warning is to be displayed, the process 198 moves to state 216 and displays the message at the display 72. If a determination is made at decision state 215 that no warning is to be displayed to the user, the process skips state 216 and terminates at an end state 217.

However, if the scan code data does correspond to an authorized medication in state 208, the wireless terminal transmits the scan code data to the server at the next communication session in state 214. Preferably, a plurality of scan codes are grouped together for transmission to the server, wherein a group comprises a patient identification code, a medication code, and a dosage. Depending on the type of medication administered, the group may also comprise a patient's vital sign such as temperature, method of administration such as oral or injection, and location of injection. Of course, embodiments of the invention are not limited to particular groupings of data for transmission to the server.

If the scan code is determined to correspond to an unexpected type of data as determined in state 204, the method 198 then moves to decision state 215 to determine if a message should be displayed to the user. There are several instances where the user should be provided with messages. For example, where the terminal 14 is being used to document and ensure accurate medication administration, the user first uses the wireless terminal to scan a code corresponding to a patient, such as a code on the patient's wristband. In response to such a code, the terminal 14 waits for additional data, and the user would proceed to scan a code on medication packaging. The wireless terminal 14 then uses the patient identification code to determine whether the code from the medication packaging is an authorized code for the patient according to the information stored in memory. In the event the scanned medication code corresponds to the authorized medication as stored in memory, the terminal 14 may display a message to indicate that the administration of the medication is authorized, dosage information, and administration information. The terminal 14 can also display a prompt to the user for entry of additional information, such as patient pulse and/or temperature. The user can enter such additional information, for example, by scanning codes corresponding to numerical digits with the terminal 14.

Following administration of a medication, a caregiver can use the terminal 14 for documentation or note taking. In particular, the user can document a reaction to a medication by scanning the appropriate code. For example, in the event a patient vomits after receiving medication, the user of the wireless terminal scans a code corresponding to the text “PATIENT VOMITED”. The terminal 14 recognizes that the code corresponds to documentation data and transmits it to the server 12 with the patient identification code during the next communication session.

Referring now back to decision state 202, if the terminal 14 determined that the received scan code corresponds to an instruction, the terminal 14 proceeds to a decision state 218. In decision state 218, the terminal 14 determines whether the instruction is to be performed by the terminal 14 or to be sent to the server 12. If the instruction is to be performed by the terminal 14, the wireless terminal executes the instruction in a state 220. The process 198 then moves to the decision state 215 to determine if a message should be displayed to the user.

If the instruction is to be sent to the server 12, the terminal 14 proceeds to a decision state 222 to determine whether the instruction is an immediate instruction, i.e. the instruction needs to be sent immediately and the terminal 14 should not wait for the next communication session. If the terminal 14 determines that the instruction is an immediate instruction in state 222, the terminal 14 transmits the instruction to the server 12 immediately in a state 224 and does not wait for the next communication session. If the wireless terminal determines that the instruction is not an immediate instruction in state 222, the terminal proceeds to a state 226 to transmit the instruction to the server 12 during the next scheduled communication session.

Thus, in one embodiment, the user of the terminal 14 scans a code corresponding to an instruction to print a report or order a laboratory test for a patient, sends a message or page, or requests information from a peripheral system connected to the server 12 by scanning the appropriate code(s) with the code scanners 80, 81. The terminal 14 then proceeds to transmit the instruction and any additional information, such as patient identification information, to the server 12 to initiate a procedure according to the instruction.

The terminal 14 can also initiate performance of an instruction, such as immediate request for assistance. For example, a user can scan a code on the wall in a patient room to request immediate assistance, wherein the code includes information regarding the location of the code as scanned. Such an instruction would be determined to be an immediate instruction in state 222 and would therefore be transmitted to the server 12 without waiting for the next communication session. In addition, the terminal 14 is configured to execute instructions or commands such as display medication data for a patient, or recall and display the last N scan code entries.

### Transmitting Data

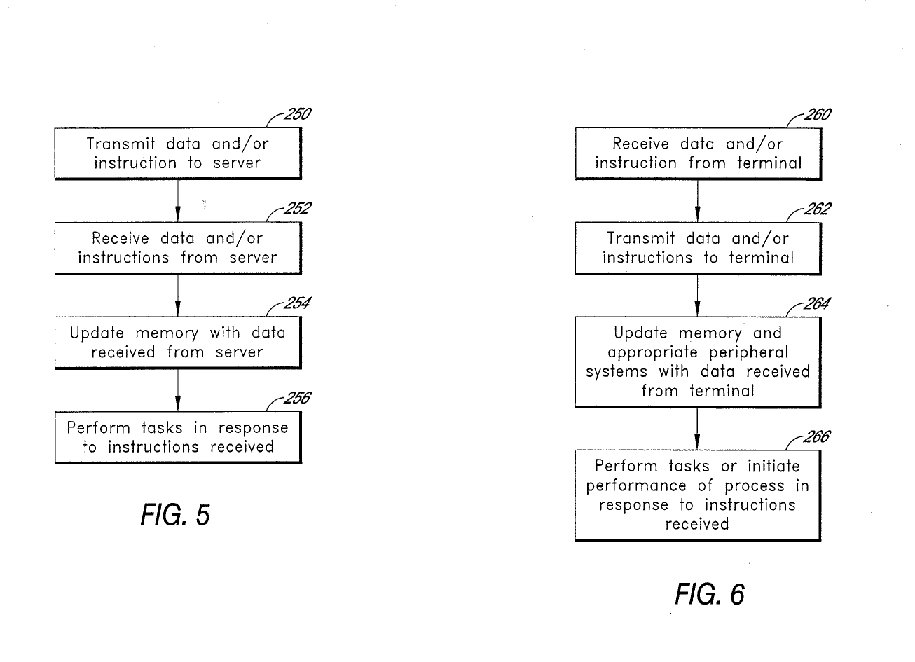

FIG. 5 is a flowchart illustrating one embodiment of a method of operation of a terminal 14 during a communication session. In a state 250, the terminal 14 transmits data and/or instructions to the server 12. In a state 252, the terminal 14 receives data and/or instructions from the server 12, and in a state 254, the terminal 14 updates memory with the data received from the server 12. In a state 256, the wireless terminal 12 performs the instructions received from the server 12, such as display of a message on the display 72.

One embodiment of a method of operation of the server 12 during a communication session with a wireless terminal is illustrated by the flowchart of FIG. 6. In a state 260, the server 12 receives data and/or instructions from the terminal 14, and in a state 262, the server 12 transmits data and/or instructions to the terminal 14. In a state 264, the server 12 updates memory 64 and the appropriate peripheral systems, such as the patient record system 30, with the data received, and in a state 266, the server 12 performs tasks or initiates performance of a process in response to instructions received from the wireless terminal 14.

### Processing Data and Instructions

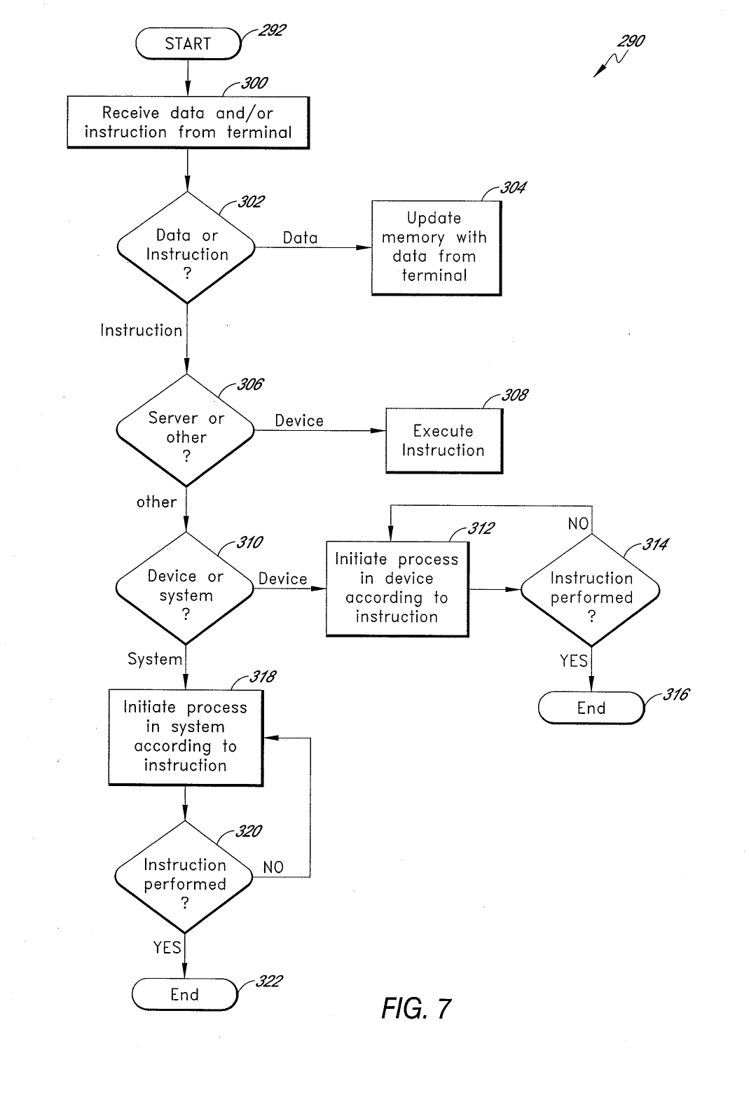

One embodiment of a method 290 of operation of the server 12 in response to receiving a scan code from a terminal 14 is illustrated in more detail in the flowchart of FIG. 7. As illustrated in FIG. 7, the method begins at a start state 292, and proceeds to a state 300 wherein the server 12 receives data and/or an instruction from the terminal 14 in the form of a scan code. In a state 302, the server determines whether the scan code corresponds to data or an instruction. If the scan code corresponds to data, the server 12 proceeds to a state 304 wherein memory 64 is updated with the data. The server 12 may also send the data to the appropriate peripheral system such as the patient record system 30.

If the scan code is determined to correspond to an instruction in state 302, the server proceeds to a state 306 to determine whether the instruction is to be performed by the server 12 or another device or system. If the instruction is to be performed by the server 12, the method proceeds to a state 308 wherein the server 12 executes the instruction. If the instruction is to be performed by a device or system other than the server 12, the server 12 proceeds to a state 310 to determine whether the instruction is to be performed by a peripheral device, such as the printer 20, or a system, such as the messaging system 22.

If the instruction is to be performed by a device, the server 12 proceeds to a state 312 where the process is initiated in the designated device according to the instruction by either sending the instruction directly to the device, or modifying and formatting the instruction and sending a formatted instruction to the designated device. Following initiation of the process in the designated device, the server 12 may query whether the instruction has been performed or completed in a state 314. If the instruction has not been performed, the server 12 can initiate the process in the designated device again by returning to state 312. If the instruction has been performed, the server 12 proceeds to an end state 316. In addition, the server 12 can send a message to the terminal 14 notifying the user that the process initiated in response to the received instruction has been completed.

If the server 12 determines in state 310 that the instruction is to be performed by a system, the server 12 initiates the appropriate process in the designated system or sends the instruction to the system designated as part of the instruction. In a state 320, the server 12 queries the system as to whether the instruction has been performed. If the instruction has been performed, the server proceeds to an end state 322, and if the instruction has not been performed the server returns to state 318 and sends the instruction to the designated system again to be performed. Alternately, if the instruction is in the process of being performed, or is waiting to be performed, the server 12 will continue to query the system until the instruction has been performed. In addition, the server 12 can notify the user of the terminal 14 that sent the instruction that the instruction has been performed by sending a message to the terminal 14 for display.

### Information Update Module

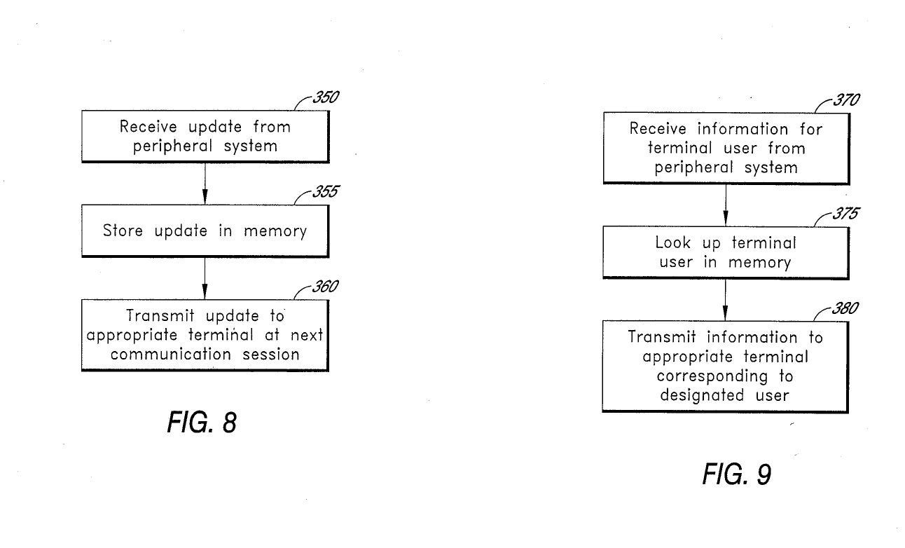

FIG. 8 is a flowchart illustrating one embodiment of a method of operation of the information update module 66 in the server 12. In a state 350, the server 12 receives an information update from a peripheral system or device, such as the pharmacy system 24, wherein the information received comprises updated medication orders for a patient or medication orders for a new or transferred patient. In a state 355, the information update module 66 stores the information in memory 64, and transmits the updated information to the appropriate terminal 14 during the next communication session.

### Messaging Module

One embodiment of a method of operation of the messaging module 70 in the server 12 is illustrated in the flowchart of FIG. 9. The messaging module 70 receives information including a message for a terminal 14 user in a state 370. In a state 375, the messaging module 70 looks for the terminal user, designated by name or ID number, in memory 64 and determines which terminal 14 to send the message to according to user information for each terminal 14 stored in memory 64. In a state 380, the messaging module 70 transmits the message to the appropriate terminal 14 using the transceiver 46 and antenna 48.

The system 10 is also capable of additional processes, such as billing or inventory control. For example, every item given or used by a patient in a hospital has a scan code applied to it or that corresponds to it in the system. When that item is used by or for the patient, the caregiver providing the item scans the patient ID code and the item code. Such information is then transmitted to a billing or record keeping system for future reference.

An additional capability of the system 10 may include entry of physician orders for patients, where a physician uses a terminal 14 to enter medication or medical care orders for a patient by scanning codes corresponding to the patient identification information, the medication to be administered, the dosage, and additional information regarding administration of the medication.

### Example Process

FIG. 10 is an example of a Medication Worksheet 400 that may be used in conjunction with a terminal 14 and server 12, operating in a system such as the hospital system 10 of FIG. 1, and using, for example, the processes of FIGS. 4-9. In one embodiment, a user such as a nurse, authorized personnel, or system administrator obtains a printed version of the Medication Worksheet 400 at the beginning of a working shift. For example, as previously discussed, the user of a terminal 14 may scan a code corresponding to an instruction to print a Medication Worksheet, and then scan a code corresponding to data identifying the user. In response to the instruction, the server 12 would facilitate printing of the Medication Worksheet for the identified user.

The Medication Worksheet 400 comprises a number of fields supplying a variety of information. For example, the Medication Worksheet 400 can include an assignment field 410 that identifies the responsible user or nurse, applicable date, and applicable shift in terms of time. The Medication Worksheet 400 can also include a patient field 420 that identifies one or more patients, their corresponding medications, and scheduled administration times for the medications.

The Medication Worksheet 400 can also include fields comprising scan codes that a user such as a nurse or authorized personnel are likely to use during their working shift, such as medication administration sites. In one embodiment, the fields include a “sites” field 430, an “override” field 440, a “keypad” field 450, and an “other” field 460.

The “sites” field 430 can include one or more scan codes associated with one or more medication administration sites or methods. For example, a user can administer medication to a first patient in accordance with the schedule shown in the patient field 420, wherein the user scans a first patient scan code 422 associated with the first patient. The user can then indicate, by scanning the appropriate scan code, the site at which a first listed medication was administered. For example, the user may scan the “1. thigh” scan code 432 to indicate that the first medication was administered via an injection to the left thigh. The terminal 14 would then transmit the information corresponding to the scan codes, such as patient information, medication, and location of medication administration, to the server 12. In response to receipt of the information from the terminal 14, the server 12 can then communicate the information to one or more modules or servers in the system, such as the patient record system 30.

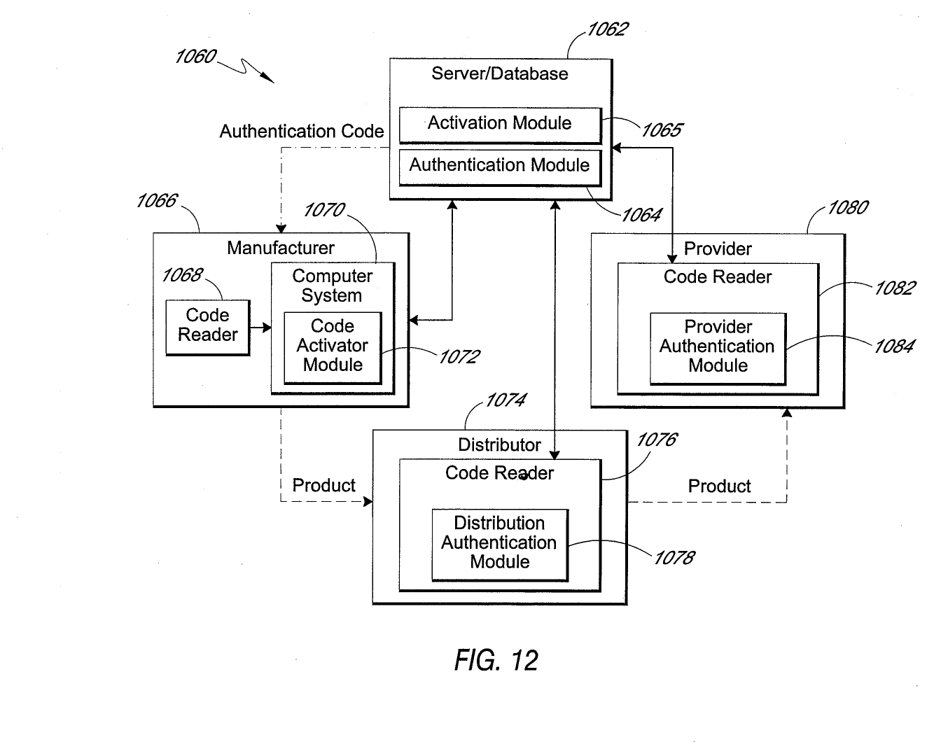

The user can similarly scan a scan code in the “override” field 440 to indicate a reason for overriding a scheduled administration of medication, such as “increased nausea”. The “keypad” field 450 can be used to compose messages or enter data for transmission to a server 12, such as patient statistics including temperature. In FIG. 12, the keypad field 450 shows a numeric keypad. In other embodiments, the Medication Worksheet 400 may include a numeric, alphanumeric, symbolic, combination thereof, or some other keypad.

The “other” field 460 can include other instructions or data entries not included in the previously described fields. For example, the “other” field 460 may include a page scan code 462 corresponding to an instruction to “page S. Felner RN”, or other designated personnel that may be currently on duty. In response to a user scanning the page scan code 460, the terminal 14 sends an instruction to the server 12, and the server facilitates a page to the listed party. In addition, the user can compose a message that is used in the page using the scan codes in the “keypad” field 450, or additional scan codes in the “other field 460 corresponding to predefined messages, such as “patient requested consultation”.

It may be advantageous to implement the scan codes on the Medication Worksheet with DOTs to identify various inputs. Unlike a barcode, the DOTs consume a small area on a standard printed page and can be positioned adjacent one another, both horizontally as well as vertically. The 2-dimensional nature of the dots allows the terminal 14 to isolate and selectively read dots that are positioned very close to one another.

The system 10 can similarly use DOTs to initially configure a terminal 14. FIG. 11 shows an embodiment of a configuration report 500 that can be generated and used to configure a terminal 14. A system administrator or other user can input information to the server 12, at the hardwired terminal 16, for example, and can thereby facilitate printing of the configuration report 500 by the printer 20 (see FIG. 1). The user can then configure the terminal 14 using the information provided in the configuration report 500, such as written instructions and a plurality of scan codes implemented with DOTs, barcodes, or a combination thereof.

In one embodiment, the system administrator inputs a server address 510 and network address 520 to the server 12. The server address can be, for example, an IP address. The system administrator can, for example, identify one of a plurality of server addresses using a pull down menu, manual entry, automated process or some other method of identifying a server. Similarly, the system administrator can identify a network from one or more available networks using a pull down menu, manual entry, automated process or some other method of identifying a server 12.

The server 12 can then process the information entered by the system administrator and generate one or more configuration scan codes 530 that can be used to configure the terminal 14. The one or more scan codes 530 can include, for example, one or more DOTs that identify or dictate a configuration operation recognized by the terminal 14. One or more additional scan codes may also be used to identify the server address and network, as well as other communication protocol. In one embodiment, the one or more scan codes in the configuration report 500 identify a Wired Equivalent Privacy (WEP) algorithm key that is used by the terminal 14 to provide security over a wireless communication channel.

In order to configure a terminal 14 using the configuration report 500, a user can simply sequentially read each scan code or DOT in the configuration report with the terminal 14. The terminal 14 is configured once all of the dots in the configuration report 500 have been read by the terminal 14.

### Tracking Pharmaceutical Products

Further aspects of the invention include a secure system and method of supplying and tracking authentic pharmaceutical products from origin at a manufacturer to a provider such as a hospital, retail pharmacy, or nursing home. The system employs authentication codes, such as machine readable codes including barcodes, or radio frequency (RF) tags, which can be applied to any level of packaging of the products to be transported from the manufacturer, including single dosage packages. A system server/database issues a number of authentication codes to a manufacturer, and the manufacturer applies the codes to product packaging and/or containers for shipment. When the products are ready for shipment, the manufacturer activates the codes (or code, depending on how many are used) by reading the authentication code with a code reader, and transmitting the code along with additional information about the product such as expiration date, type of product or medication, and shipment information such as destination and time for shipment, for example, to the system server/database. Communication with the system server/database can take place over a secure web link, for example, to ensure the security of the authentication code being activated.

When the manufacturer ships the products directly to the provider, the provider can verify that the products received are those that were shipped by the manufacturer by reading the authentication codes on the shipping container, package, or single dose packages using a code reader. The code is transmitted to the system server/database, along with information regarding the provider location, and the system server/database provides verification as to whether the code read at the provider corresponds to the code activated by the manufacturer, and whether the provider location matches the destination location corresponding to the activated code.

Once the activated authentication code is read at the final destination specified by the manufacturer and stored in the server/database, the code is then expired in the system server/database. Substitute or counterfeit products can thus be identified because only the products received at the provider having the active authentication code will correspond to the authentication code activated by the manufacturer and stored in the system server/database. Attempts by a provider to authenticate a product having an expired authentication code will fail, thus notifying the provider that the product may be counterfeit.

When there are intermediate destinations in the distribution chain of a pharmaceutical product, authenticity can be verified at every location along the distribution chain. In addition, the location of the product can be tracked, as each time the activated authentication code is read by a code reader requesting verification from the system server/database, the physical location of the code reader that makes the request can be stored at the system server/database. Alternately, if a substitute or counterfeit authentication code is read by a code reader at an intermediate destination, the system server/database can indicate that the authentication code has not been activated by a manufacturer and is invalid. The server/database can notify the manufacturer and provider that a substitute product has attempted to enter the distribution chain.

Verification of an authentication code preferably includes correlation of at least one data element or informational element in addition to the authentication code, such as a product's intended destination. The data element or informational element is also preferably unrelated to or indiscernible from product packaging. Thereby, a would-be counterfeiter would only be able to copy one element (the authentication code) necessary for verification of a product from product packaging, and the additional data element would remain unknown. The additional data element or informational element is not limited to the intended destination or destinations of a product, and other types or categories of information are contemplated. In addition, the type or category of information used by the tracking system for verification of an authentication code may be altered periodically.

### Pharmaceutical Tracking System Overview

One embodiment of a secure pharmaceutical distribution and tracking system 1060 is illustrated in FIG. 12. The system 1060 comprises a central system server/database 1062 with an authentication module 1064 and an activation module 1065. The server/database 1062 generates and provides a number of authentication codes to a manufacturer 1066, wherein the authentication codes can be transmitted to the manufacturer electronically or distributed manually. The system 1060 further comprises, at the manufacturer 1066, a code reader 1068 and a computer system 1070, wherein the computer system 1070 comprises a code activator module 1072 configured to activate an authentication code in conjunction with the activation module 1065 at the server/database 1062.

The manufacturer 1066 applies or affixes an authentication code to the product to be shipped or distributed, and inputs the affixed authentication code to the computer system 1070 by reading the authentication code with the code reader 1068. The code reader 1068 is configured to communicate with the computer system 1070 via a wireless link or wired connection, and may include an input device to receive information from a user, such as product information. The computer system 1070 may also include a user input device configured to receive input from a user, such as user, product, manufacturer, and destination information. The computer system 1070 and/or code reader 1068 may also include memory for storing manufacturer information, wherein transmission of an authentication code from the code reader 1068 or computer system 1070 to the server/database 1062 includes the stored manufacturer information.

The code activator module 1072 receives an authentication code read by the code reader 1068 at the manufacturer 1066 and generates an activation request. The code activator module 1072 transmits the activation request and authentication code, along with corresponding information such as type and quantity of the product, intended destinations, and time for shipment, to the system server/database 1062. In one embodiment, the code activator module 1072 modifies or encodes the activation request, authentication code, and corresponding information according to a predefined modification or encoding scheme prior to transmission to the server/database 1062. The code activator module 1072 also communicates with the system server/database 1062 so as to receive confirmation that authentication codes are activated, notification of authentication code verification attempts by distributors and providers and the corresponding location of such requests, confirmation of products received at a provider, and expiration of authentication codes.

The activator module 1072 may also be configured to query the system server/database 1062 for information regarding the current location or tracking history for the shipped product and corresponding activated authentication codes, and may update additional information associated with an activated authentication code and stored at the server/database 1062. The computer system 1070 may also comprise a server for storing a list of activated authentication codes corresponding to individual products or dosages as part of a shipment, wherein the stored activated authentication codes can later be correlated with authentication codes affixed to products or dosages received at a distributor or final destination. Accordingly, the code activation module 1072 can also be configured to store the activated authentication codes in the local server or database at the manufacturer 1066.

The activation module 1065 at the server/database 1062 receives the activation request, authentication codes, and corresponding information from the code activator module 1072 for activation of authentication codes in the tracking system 1060. In response to receipt of the activation request, the activation module 1065 flags the received authentication codes at the server/database 1062 as “ACTIVE”, and stores all or a portion of the additional information sent with the authentication code. The activation module 1065 may be configured to decode the modification scheme used by the code activator module 1072, when such a modification scheme is used, prior to storing the authentication codes and corresponding information.

The activation module 1065 is also configured to communicate with the code activator module 1072 so as to provide it with information, such as a list of confirmed ACTIVE authentication codes, confirmed delivery of the product at the provider, product end user information, and expiration of authentication codes.

The activation module 1065 at the server/database 1062 is further configured to transmit the ACTIVE authentication code and at least one additional piece of information, such as the intended final destination of the product associated with the authentication code, to designated verification entities in the shipping chain, such as distributors and a provider. For example, where a product is scheduled to be transferred from the manufacturer to a distributor, and from the distributor to the final destination, the server/database 1062 transmits the ACTIVE authentication code and associated final destination information to the designated distributor and the final destination. Thereby, the authentication code affixed to the shipped product can be verified locally at the distributor and final destination upon receipt of the product rather than querying the database for verification of an authentication code. Due to the local storage of the authentication code, the time for completion of an authentication code verification and the overall data traffic to the database/server 1062 are reduced. Furthermore, in the event the server/database 1062 is unavailable, or the communication link between a code reader and the server/database 1062 is inoperable, authentication codes can still be verified locally at the distributor and provider locations.

The tracking system 1060 further comprises, at a distributor 1074, a code reader 1076 and a distribution authentication module 1078, wherein the code reader 1076 is configured to read the machine readable authentication codes affixed to products received from the manufacturer and to communicate with the server/database 1062. In one embodiment, the distribution authentication module 1078 is implemented at the code reader 1076, and the code reader 1076 is configured to store ACTIVE authentication modules and associated additional information as received from the server/database 1062.

The code reader 1076 is preferably configured to communicate with the server/database 1062 via a combination of a wireless communication link and a network such as the Internet. In addition, the code reader 1076 may include an input device configured to receive input from a user including, but not limited to, product, time and/or date of receipt, shipping, user, and current location information. The code reader 1076 also preferably includes a real time clock and memory, and is configured to time stamp code reading events and store information about the distributor 1074, such as location information.

The distribution authentication module 1078 is configured to perform a verification procedure for an authentication code read by the code reader 1076. In response to receiving an authentication code, the distribution authentication module 1078 compares the received authentication code with ACTIVE authentication codes received from the server/database 1062, and attempts to correlate any additional information, such as product type, distributor information, and final destination information with that received from the server/database 1062. If the distribution authentication module 1078 verifies that the authentication code read by the code reader 1076 is ACTIVE and the additional information, such as quantity or destination information, is confirmed, the module 1078 notifies the distributor of such verification and confirmation via either an audio or visual indicator at the code reader 1076.

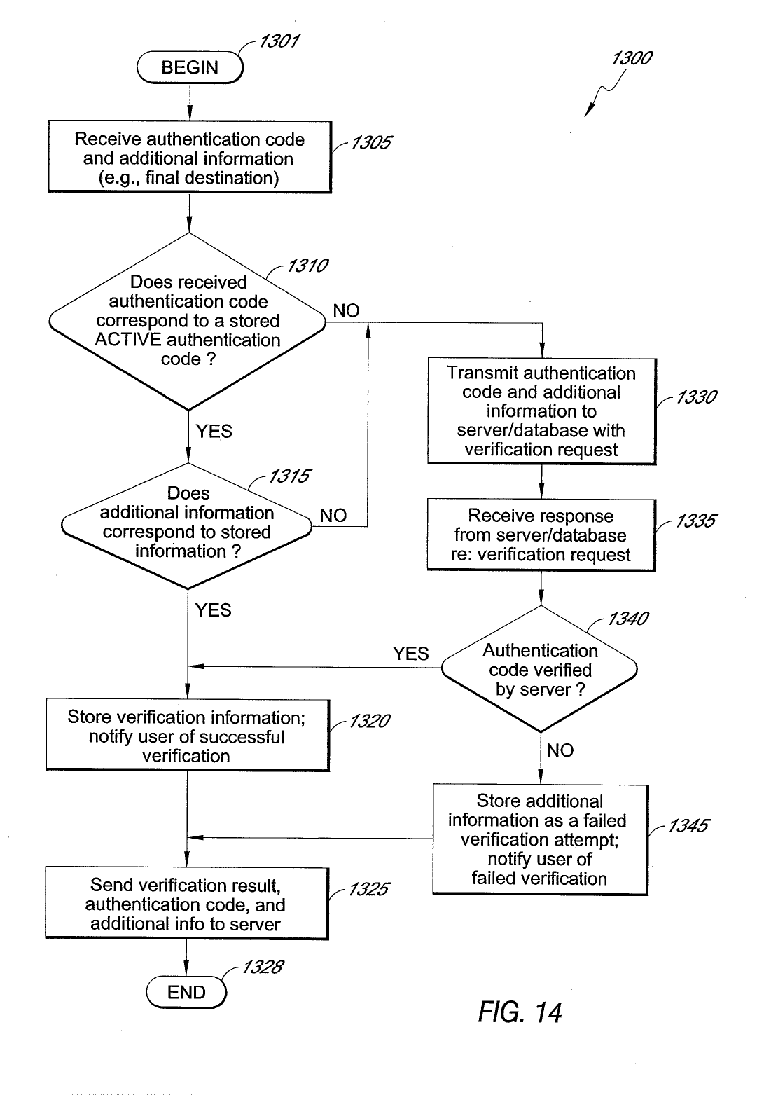

If the distribution authentication module 1078 is unable to verify the authentication code, it queries the server/database 1062 with the authentication code and additional information. In the event the server/database 1062 verifies that the authentication code is ACTIVE and the additional information matches that stored at the server/database 1062, the distribution authentication module 1078 is notified and the code reader 1076 in turn notifies the user that the authentication code has been verified. In the event the authentication code and/or additional information do not correlate with information at the server/database 1062, the distribution authentication module 1078 notifies the distributor that the authentication code is not ACTIVE, that the destination is incorrect, or that the quantity of units is incorrect. Thereby the distributor can identify substitute products or missing products and take the appropriate action. One embodiment of a method of verifying an authentication code is discussed in further detail hereinafter below in connection with FIG. 14.

The tracking system 1060 also comprises, at a provider 1080, a code reader 1082 having a provider authentication module 1084, wherein the code reader 1082 is configured to read the machine readable authentication codes affixed to products received, and to communicate with the server/database 1062. The code reader 1082 may include an input device configured to receive input from a user including, but not limited to, product, time and/or date of receipt, shipping, user, and current location information. The code reader 1082 may also include a real time clock and be configured to time stamp code reading events, and may include memory for storing information about the provider 1080, such as location information.

The provider authentication module 1084 is configured to verify the authenticity of products received using the authentication code read by the code reader 1082. The code reader 1082 is preferably configured to communicate with the server/database 1062 via a combination of a wireless communication link and a network such as the Internet.

Similar to the distribution authentication module 1078, the provider authentication module 1084 is configured to perform a verification operation for an authentication code read by the code reader 1082. In response to receiving an authentication code, the provider authentication module 1084 compares the received authentication code with ACTIVE authentication codes received from the server/database 1062, and attempts to correlate any additional information, such as product type, provider information, and final destination information with that received from the server/database 1062. If the provider authentication module 1084 verifies that the authentication code read by the code reader 1082 is ACTIVE and the additional information, such as quantity or destination information, is confirmed, the module 1084 notifies the provider of such verification and confirmation via either an audio or visual indicator at the code reader 1082.

If the provider authentication module 1084 is unable to verify the authentication code, it queries the server/database 1062 with the authentication code and additional information. In the event the server/database 1062 verifies that the authentication code is ACTIVE and the additional information matches that stored at the server/database 1062, the provider authentication module 1084 is notified and the code reader 1082 in turn notifies the user that the authentication code has been verified. In the event the authentication code and/or additional information do not correlate with information at the server/database 1062, the provider authentication module 1084 notifies the provider that the authentication code is not ACTIVE, that the destination is incorrect, or that the quantity of units is incorrect. Thereby the provider can identify substitute products or missing products and take the appropriate action. One embodiment of a method of verifying an authentication code is discussed in further detail hereinafter below in connection with FIG. 14.

The provider authentication module 1084 can also be configured to send end user information to the system server/database. Furthermore, the provider information will be the final destination information, and therefore entry of final destination information by the user may be unnecessary to verify an authentication code where the code reader 1082 at the provider 1080 stores provider information, and the authentication module 1084 attempts to correlate the stored provider information with the final destination information received from the server/database. For example, where the tracking system 1060 requires correlation of an authentication code with an ACTIVE authentication code, and correlation of final destination information with that provided by the manufacturer, then the user of the code reader at the provider need only read the authentication code with the code reader 1082 in order to determine whether the authentication code is valid.

The authentication module 1064 at the server/database 1062 is configured to receive and process authentication requests from the distribution authentication module 1078 and provider authentication module 1084 in order to verify that an authentication code from such modules corresponds to an ACTIVE authentication code stored at the server/database 1062. Verification of an authentication code includes determining whether the received authentication code is ACTIVE, and may also include correlation of product type, quantity, distributor or provider information, and final destination information with corresponding information stored at the server/database 1062. The authentication module 1064 may be configured to generate and send a notification message to the manufacturer in response to a verification request from a distributor or provider, wherein the message may include distributor or provider information in relation to a failed verification request, for example. In addition, the server/database 1062 is configured to transmit information designated for the manufacturer 1066 as received from distributors 1066 and providers 1080, such as notifications regarding successful or unsuccessful authentication code verifications.

The tracking system 1060 may additionally comprise computers at the distributor 1074 and/or the provider 1080, wherein the distribution authentication module 1078 and provider authentication module 1084 may alternately be implemented in the computers and the computers are configured to communicate with the server/database 1062. In such an embodiment, ACTIVE authentication codes and corresponding additional information may be stored at the computers, and the code reader may query the computer for verification of an authentication code. In another embodiment, the code readers 1076, 1082 are configured to interface with a communication device configured to communicate with the server/database 1062.

In one embodiment, the server/database 1062 does not transmit the ACTIVE authentication codes and additional information to the distributor and provider, and the authentication modules at the distributor and provider preferably queries the server/database 1062 for verification of an authentication code. It will be appreciated that the system can be implemented in an environment employing a plurality of distributors or intermediate shipping points between the manufacturer and the provider, and that the system described and illustrated is exemplary of one embodiment of the invention.

### Secure Method of Product Distribution Tracking

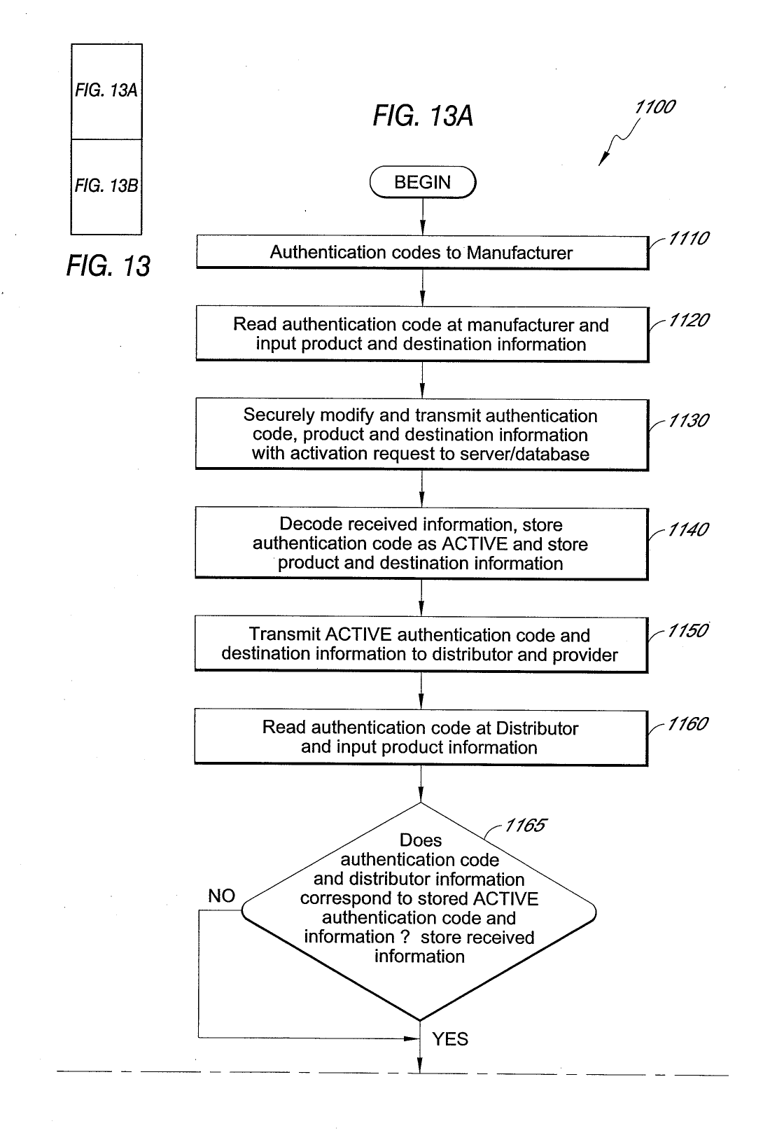

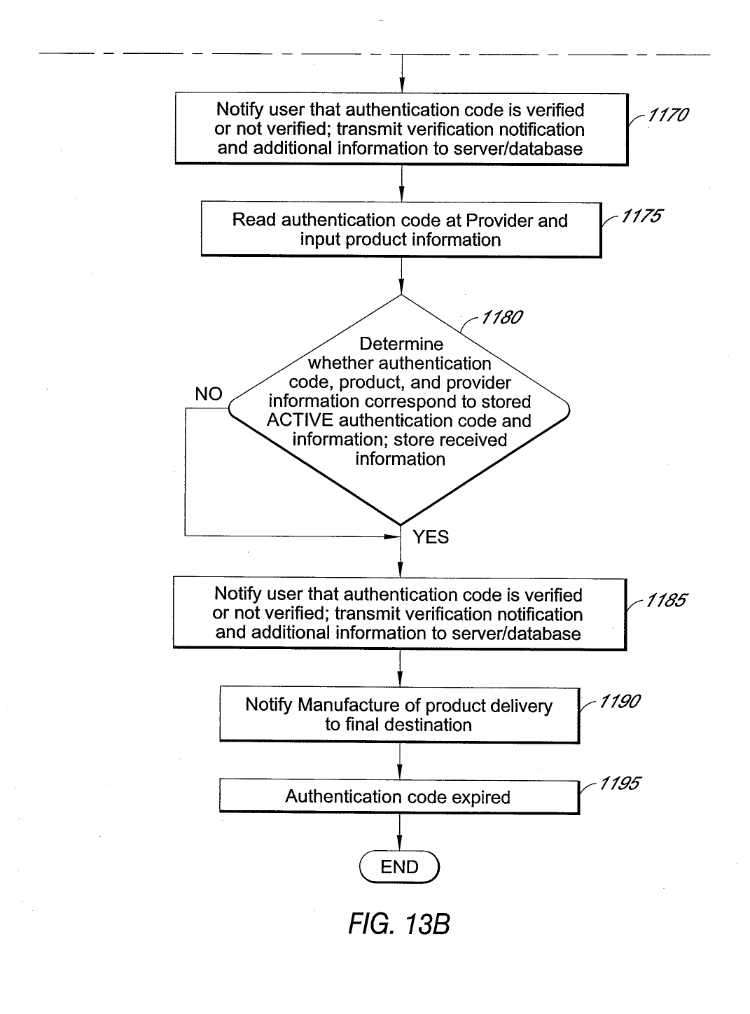

FIG. 13 is a flow diagram illustrating one embodiment of a method 1100 of operating the tracking system 1060. In a step 1110, the system server/database 1062 sends a plurality of authentication codes to the manufacturer 1066, and the manufacturer 1066 applies or affixes the codes to the product to be shipped or distributed. As previously discussed, the authentication codes may be provided to the manufacturer 1066 electronically, such as over the Internet, or manually shipped to the manufacturer. The codes can be affixed by, for example, printing a machine readable version of the codes on a label which is then affixed to the product. Examples of machine readable codes include one dimensional barcodes, two dimensional barcodes, and RFID tags.

In a step 1120, the manufacturer inputs an authentication code, affixed to a product, into the computer system 1070 by reading the authentication code with the code reader 1068. In addition to inputting the authentication code, the manufacturer inputs product and destination information associated with the authentication code, or associates the authentication code with product and destination information already stored at the computer system 1070. The destination information may include intermediate destination and final destination information. Thereby, product and destination information are associated with the authentication code within the computer system 1070. In a step 1130, the code activator module 1072 securely modifies or encodes the authentication code and product and destination information, and transmits the encoded information to the server/database 1062 along with an activation request. In a step 1140, the server/database 1062 receives the modified authentication code and corresponding information from the manufacturer 1066, and decodes the information. The activation module 1065 activates the authentication code by storing the authentication code with an “ACTIVE” status, along with the corresponding additional information or portion thereof from the manufacturer.

In a step 1150, the server/database 1062 transmits the ACTIVE authentication codes and preferably at least one additional piece of information, such as the destination of the product associated with the ACTIVE authentication code, to the distributor 1074 and the provider 1080 as designated by the manufacturer 1066.

When a product is received at the distributor 1074, the distributor 1074 inputs the authentication code into the code reader 1076 by reading the authentication code on the received product in a step 1160. The distributor 1074 may also input product information or additional information, such as expected manufacturer information, distributor information, and final destination information. In a step 11065, the distribution authentication module 1078 determines whether the authentication code corresponds to an ACTIVE authentication code as received from the server/database 1062 in step 1150. If the distribution authentication module 1078 determines that the authentication code corresponds to an ACTIVE authentication code, then the distribution authentication module 1078 further determines whether the additional information, such as product, manufacturer, distributor, and/or final destination information correspond to the additional information received from the server/database 1062 in connection with the ACTIVE authentication code. Depending on whether the additional information corresponds to that received from the server/database 1062, the distribution authentication module 1078 stores the received authentication code and additional information as either a verified authentication or failed verification in step 1165. In a step 1170, the distribution authentication module 1078 notifies the distributor of the result of the verification, and transmits the result of the verification and additional information, such as additional distributor information and time of product receipt, to the server/database 1062.

The distribution authentication module 1078 may be configured to transmit authentication code verification results and corresponding information at predefined times or according to the number of verification attempts, and may be configured to transmit such information once per day, for example, rather than after each verification event. In addition, as will be discussed in further detail hereinafter in connection with FIG. 14, the distribution authentication module 1078 may query the server/database 1062 in the event the authentication code does not correspond to a stored ACTIVE code, and/or the additional information does not correspond to that received from the server/database 1062. One embodiment of a method of verification of an authentication code and additional information is discussed in more detail hereinafter below in connection with FIG. 14.

In a step 1175, the authentication code is read by the code reader 1082 at the provider 1080, and the provider may also input product or additional information, such as product information and provider information. In a step 1180, the provider authentication module 1084 determines whether the authentication code read by the code reader 1082 corresponds to an ACTIVE authentication code as received from the server/database 1062 in step 1150. If the authentication code corresponds to an ACTIVE authentication code, then the provider authentication module 1084 further determines whether the additional information, such as the provider information, corresponds to the additional information received from the server/database 1062. For example, the provider authentication module 1084 may determine whether the provider information corresponds to the final destination information provided by the manufacturer 1066. Depending on whether the additional information corresponds to that received from the server/database 1062, the provider authentication module 1084 stores the received authentication code and additional information as either a verified authentication or failed verification in step 1180. In a step 1185, the provider authentication module 1084 notifies the provider of the result of the verification, and transmits the result of the verification and additional information, such as provider information, to the server/database 1062.

In a step 1190, the system server/database 1062 sends a notification to the manufacturer 1066 that the product was delivered to the final destination, and any provider information is also transmitted. In a step 1195, the authentication code originally activated by the manufacturer 1066 and verified by the provider 1080 is expired by the system server/database 1062 by flagging the authentication code as “EXPIRED”. Where a number of distributors or intermediary locations are used along the distribution chain of the product, steps 1150 through 1170 can be repeated for each distributor or intermediary location to verify the authenticity of the product received and to track the product location.

Excess or surplus authentication codes at the manufacturer create no risk because only authentication codes that have been activated will be verified by the system server/database as corresponding to an authentic product from the manufacturer. In addition, activation of the authentication codes is controlled by the manufacturer, where only the manufacturer receives authentication codes available for activation, and only the manufacturer can activate the codes over a secure communications link using a secure activation scheme.

In one embodiment, manufacturer information, such as the name of the manufacturer and a corresponding identification code, is stored in connection with an ACTIVE authentication code at the system server/database. In this embodiment, a verification request failing to include the expected or stored manufacturer information would result in a failed verification attempt. Thereby, in the event identical authentication codes are inadvertently activated in the tracking system, the server/database will not verify an authentication code unless the entity requesting verification also inputs the expected manufacturer information.

Furthermore, in the event an active authentication code is read more than once at a specified destination, the system can immediately identify the location of the duplicate reading and notify the manufacturer and provider that a product with a duplicate active authentication code has attempted to enter the distribution chain.

In addition, since the location of each authentication code is read and reported to the system server/database along with an authentication code validation request, the product can be tracked from location to location through the distribution chain. Any attempt to read an authentication code read instance which results in an invalid authentication is also recorded with respect to the location where the validation originated. By tracking this information, the point of attempted entry of substitute products can be identified by the system. Furthermore, the number of invalid authentication code readings at a particular location can be tallied and stored in the system server/database such that locations with a large number of invalid readings can be identified as suspect for security problems.

The code activator module 1072, authentication module 1064 in the system server/database 1062, distribution authentication module 1078, and provider authentication module 1084 are described below in further detail. It will be appreciated that each of these modules can be implemented in a computing system with communications capabilities, or the code activator module 1072, distribution authentication module 1078, and provider authentication module 1084 can be wholly or partially implemented in the code readers 1068, 1076, 1082. Communication with the system server/database 1062 preferably uses a secure communications link, such as a secure web link, and a virtual private network can be implemented for the particular members of the distribution chain. The code readers 1068, 1076, 1082 can be implemented with network communication capabilities, such that they can communicate, for example, over the Internet or an intranet with the system server/database 1062.

### Authentication Code Verification

FIG. 14 is a software flow diagram illustrating one embodiment of a method 1300 of processing a verification request at the distribution authentication module 1078 or the provider authentication module 1084. For simplicity purposes, the description of the method 1300 will refer to the distribution authentication module 1078. The method 1300 begins at a step 1301 and proceeds to a step 1305. In step 1305, the authentication module 1078 receives an authentication code and additional information at the code reader 1076. The additional information may include, for example, product information, information about the location or entity requesting verification, such as distributor information, final destination information, and product manufacturer information. The additional information received by the authentication module 1078 may be retrieved from memory at the code reader 1076, such as distributor information. In a step 1310, the authentication module 1078 determines whether the received authentication code corresponds to an ACTIVE authentication code received from the server/database 1062 and stored at the code reader 1076. If the authentication module 1078 determines in step 1310 that yes, the received authentication code corresponds to an ACTIVE authentication code, then the authentication module 1078 proceeds to a step 1315.

In step 1315, the authentication module 1078 determines whether the additional information, such as the final destination information, corresponds to the additional information received from the server/database 1062 in relation to the ACTIVE authentication code. If the authentication module 1078 determines in step 1315 that the additional information does correspond to the information received from the server/database 1062 in relation to the ACTIVE authentication code, then the authentication module 1078 proceeds to a step 1320. In step 1320, the authentication module 1078 stores the additional information or portion thereof in relation to the ACTIVE authentication code as a successful verification, and generates a verification notification to notify the user of the code reader 1076 of the successful verification in step 1320. The user of the code reader 1076 may be notified via an audio or visual indicator, for example. In step 1325, the authentication module 1078 sends the verification result, authentication code, and additional information to the server/database 1062, and the method is terminated in a step 1328.

If the authentication module 1078 determines in step 1310 that the received authentication code does not correspond to an ACTIVE authentication code, then the authentication module 1078 proceeds to a step 1330. Similarly, if the authentication module 1078 determines in step 1315 that the additional information does not correspond to the information received from the server/database 1062 in relation to the ACTIVE authentication code, then the authentication module 1078 proceeds to step 1330. In step 1330, the authentication module 1078 transmits the authentication code, additional information, and a verification request to the server/database 1062. The authentication module 1064 at the server/database 1062 performs steps similar to steps 1310 and 1315 in response to receipt of the verification request, and generates and sends a response to the verification request according to the determinations regarding whether the authentication code is ACTIVE and whether the additional information corresponds to that stored at the server/database 1062. The distribution authentication module 1078 receives the response from the server/database 1062 regarding the verification request in a step 1335, and proceeds to a step 1340.

In a step 1340, the authentication module 1078 determines whether the response to the verification request from the server/database is a notification of a successful or unsuccessful verification of the authentication code sent in step 1330. If the authentication module 1078 determines in step 1340 that the authentication code was verified as ACTIVE and the additional information matched that stored at the server/database 1062, then the authentication module 1078 proceeds to step 1320, which is discussed above. If the authentication module 1078 determines in step 1340 that the authentication code was not verified as ACTIVE and/or the additional information did not correspond to that stored at the server/database 1062, then the authentication module 1078 proceeds to a step 1345.

In step 1345, the authentication code and additional information are stored as a failed verification attempt and the authentication module 1078 generates a failed verification notification to notify the user of the code reader 1076 of the unsuccessful verification. Notification of the unsuccessful verification may include detailed information as to which information the authentication module 1078 or server/database 1062 was unable to verify, such as distributor information, manufacturer information, and final destination. Thereby the distributor can identify substitute products or missing products and take the appropriate action. Following step 1345 the method 1300 proceeds to step 1325, discussed above.

In one embodiment, the authentication module 1078 is further configured to confirm product type and quantity information, where a combination of codes corresponding to a combination of units such as a mixed shipment, or different codes on different levels of packaging, have been activated by the manufacturer as a single set of authentication codes, and the authentication module 1078 can identify any missing codes from the set upon requested authentication of any portion of the set. The authentication module may additionally be configured to notify the manufacturer via the server/database of such findings.

As can be appreciated by one of ordinary skill in the art, each of the modules discussed above comprise various sub-routines, procedures, definitional statements and macros. Each of the modules are typically separately compiled and linked into a single executable program. Therefore, the above description of each of the modules is used for convenience to describe the functionality of the preferred system. Thus, the processes that are undergone by each of the modules may be arbitrarily redistributed to another module in the system.

In addition to authenticity verification upon receipt of the pharmaceutical product from a distributor or manufacturer, point of use validation can also take place where the authentication code on individual dosage medication packaging is read by a code reader for validation at the time the medication is administered or provided to a patient. Thereby, information regarding the date of administration of the medication, information about the patient, and the symptoms exhibited by the patient warranting administration of the medication are communicated to the manufacturer so as to monitor the types of patients, reasons for using the medication, frequency of use of the medication, and time period between manufacture and administration of a medication.

In some embodiments, the code reader at each location in the distribution chain can be preprogrammed with specific information about the location, such as physical location, type of facility, name of facility, and identity of an operator or user. Alternately, the tracking system includes a computing system configured to transmit the specific location information with the authentication code validation request to the system server/database.

For ease and low cost of integration into existing systems, optical scanning codes such as barcodes can be used, and the code reader can be implemented as an optical scanning device such as a barcode scanner, where barcode scanning technology is currently a substantially developed and widely implemented and available technology. Such implementations provide for faster data processing, and therefore faster authentication of the pharmaceutical products.

### Disposable Equipment

There are a variety of types of disposable articles in a medical or laboratory environment. Some types of disposable equipment might include, for example, micro tubes, Petri dishes, screw caps, urine specimen containers, bleeding time devices, biohazard containers, transfer pipettes, slide mailers, sterile polyethylene caps, needle containers, needles, bottles or other containers for mothers' milk, circle cytoslides, falcon caps, Pasteur pipettes, envirotips pipette, thermometers, pipette tips, centrifuge tubes, micro centrifuge tubes, sterile vials, disposable lab coats, plug-tight caps, Kova super tubes, disposable applicators, glucose tolerance beverages, micro tubes with screw caps, Kova caps, blood collection needles, culture dishes, phenolic screw-type black caps, polypropylene autoclave bags, parapak collections systems, fungus bottle, MacConkey agar, Brucella agar, tissue grinder, falcon tube, triton, super clear centrifuge tube, vacuum assembly and valve, eppendorf pipette, Teflon tips, rubber bulbs, tip dispensers, envirotips, water testing kit for anionic detergent, ferrule vespel, septa, syringes, capillary columns, urinalysis slides, ferrule capillaries, shipper diagnostic substances, shipper infectious substance, tite plug cap, Para film, press fit caps, transfer pipettes, fine transfer pipettes, blades, scalpel remover blades, formalin prefitted containers, disposable weighing dishes, histological clearing agents, tissue cassettes, cover glasses, watch glasses, surgical sterile scalpels, lubrication kits, biopsy bags, lid cassettes, specimen containers, histoscreen cassettes, fixative cytology, microscope slides, brushes, cervical scrapers, double-sided blades, impervious gowns, sealing rings, autopsy knives, Foley bags, colostomy bags, urostomy bags, IV bags, versaclosure tubes, numerous types of flasks and the like.

### Sample Collection Containers

Sample collection containers are among the most common types of disposable articles in a medical or laboratory environment. Sample containers may differ in size, thickness, material or chemical additive. Currently, there are a variety of different types of commonly used sample collection containers. In a hospital environment, types of sample collection containers might include, for example, syringes, eppendorf tubes, falcon tubes Petri dishes, IV bags, micro tubes, urine specimen containers, transfer pipettes, mailer slides, needle containers, Pasteur pipettes, envirotip pipettes, centrifuge tubes, sterile vials, Kova super tubes, centrifuge tubes, culture dishes, autoclave bags, bottles, super clear centrifuge tubes, eppendorf pipettes, rubber bulbs, urinalysis slides, microscope slides, ferrule capillaries, formalin containers, biopsy bags, Foley bags, colostomy bags, urostomy bags, and the like. Certain sample collection containers might be used to store or deliver mothers' milk to an infant. These types of sample collection containers for mothers' milk will be discussed further below.

Among the most common types of sample collection containers are glass and plastic sample tubes, including test tubes. Evacuated glass and plastic sample tubes, closed and sealed with colored rubber stoppers, are among the most common sample collection containers used to collect and transport patient blood samples in hospitals. Billions of sample tubes are consumed by health care providers each year. One type of these sample collection containers, called Vacutainers®, may be purchased in bulk by hospitals from companies like Becton-Dickinson (Franklin Lakes, N.J.).

Vacutainers are particularly useful in a hospital environment for drawing blood. For example, a vein punctured with a first hypodermic needle is connected to a translucent plastic holder. A second, smaller needle is then connected to the first needle. When a Vacutainer test tube rubber cap is pierced by the second needle, a partial vacuum in the sample tube draws blood though the needles to fill the Vacutainer test tube. The Vacutainer tube is then removed. Multiple Vacutainer tubes may then be filled using the same needles in the same manner.

A sample collection container may have a color-coded plastic cap indicating a type of chemical additive that the sample tube contains. For example, an opaque cap on a Vacutainer test tube would indicate a tube with a normal vacuum and a translucent cap on a Vacutainer test tube might indicate a weaker vacuum. Weaker suction would be advantageous for smaller sized veins or when a normal vacuum might cause the collapse of veins of elderly people or those with delicate veins.

Many of the sample tubes currently available (including Vacutainer test tubes) contain various types of chemical additives. Chemical additives in sample tubes used for drawing blood might include, for example, lithium salt of heparin (an anticoagulant); a sodium salt of heparin (an anticoagulant); ammonium salt of heparin; EDTA (ethylenediaminetetraacetic acid) (an anticoagulant); and Potassium Oxalate/Sodium Fluoride (Fluoride prevents enzymes in the blood from working, so a substrate such as glucose will not be gradually used up during storage and Oxalate is an anticoagulant); Citrate (a reversible anticoagulant used for coagulation assays); and thrombin (which makes blood clot extremely rapidly and thus allows the serum to be analyzed more quickly). Another type of chemical used in sample tubes for drawing blood is a gel with an intermediate density between blood cells and blood plasma. Thus, when the sample tube is centrifuged and the red blood cells are separated from the blood plasma, the gel migrates to a position between the blood cells (on the bottom of the sample collection containers) and the plasma (on the top of the sample collection containers).

Other types of sample collection containers may contain material designed to culture a sample placed therein. Such sample collection containers might include Petri dishes, Chlamydia swabs, watch glasses, MacConkey agar, Brucella agar, tissue grinders, falcon tubes, and the like.

Although a shelf life for certain types of sample collection containers may be measured in years, the shelf life for some sample collection containers, including those with chemical additives or preparations may be much shorter.

### System Overview

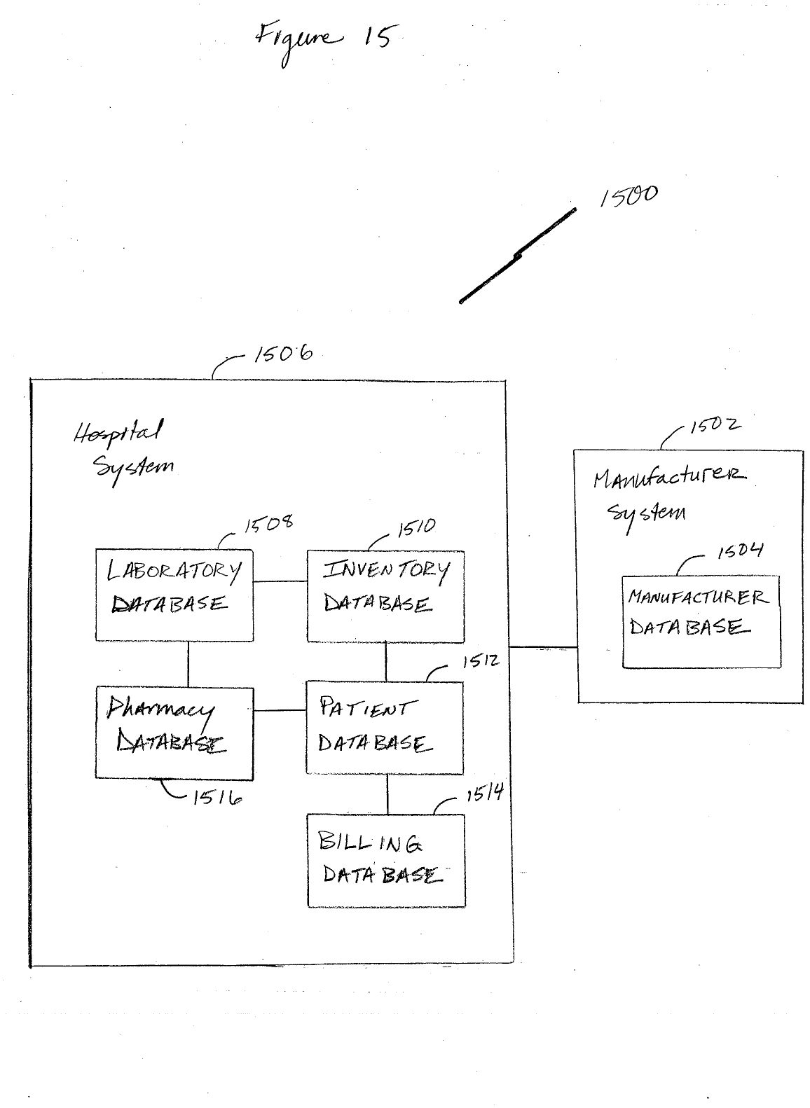

FIG. 15 is a block diagram of one embodiment of a system for cumulatively associating manufacturing data and patient data 1500. It shows a manufacturer database 1504 contained within a manufacturer system 1502. The manufacturer system 1502 is connected to a hospital system 1506. The hospital system 1506 comprises a laboratory database 1508, an inventory database 1510, a patient database 1512, a billing database 1514 and a pharmacy database 1516. Each of these databases will be discussed in further detail with regard to FIGS. 16-21.

### Manufacturing Unique Sample Collection Containers

FIG. 16 is a flow diagram illustrating one embodiment of a method 1600 performed within the manufacturer system 1502. In step 1602 a sample collection container is provided. In step 1604, the system selects a code to affix on the sample collection container. Types of codes might include two dimensional codes, dot matrix codes, RFID codes or a DOT™ code. In decision state 1606, the system determines if the code selected has been used previously. If so, the code is discarded in state 1608 and the system returns to the code selection state 1604 to select another code. If the code had not been used previously, then the system determines that the code is unique and proceeds to the next state. In state 1610, the unique code is permanently affixed to a sample collection container.

Thereafter, the system associates manufacturing data of the sample collection container with the particular code affixed to the sample collection container at a state 1612. This manufacturing data may indicate standard manufacturing data, for example, a brand name, a product type, a product size and/or a lot number. The manufacturing data might also include other information about the particular manufacture, a date of manufacture, a place of and/or conditions of manufacture. The manufacture data might also include a product expiration date. Additionally, certain types of disposable articles, including sample collection containers, might contain various types of chemicals or other added features that might be included in the manufacture data associated with the particular code. The system associates the manufacture data with the code using a database, which contains the manufacturing data and the codes for each sample container. The system can thereafter share the manufacturing data and codes from the database with hospitals, laboratories or other entities purchasing the sample collection containers.

After manufacture data of a sample collection container has been associated with the particular code affixed to the container at the state 1612, the code and the manufacture data are saved in the manufacturer database at a state 1614.

### The Medical Environment

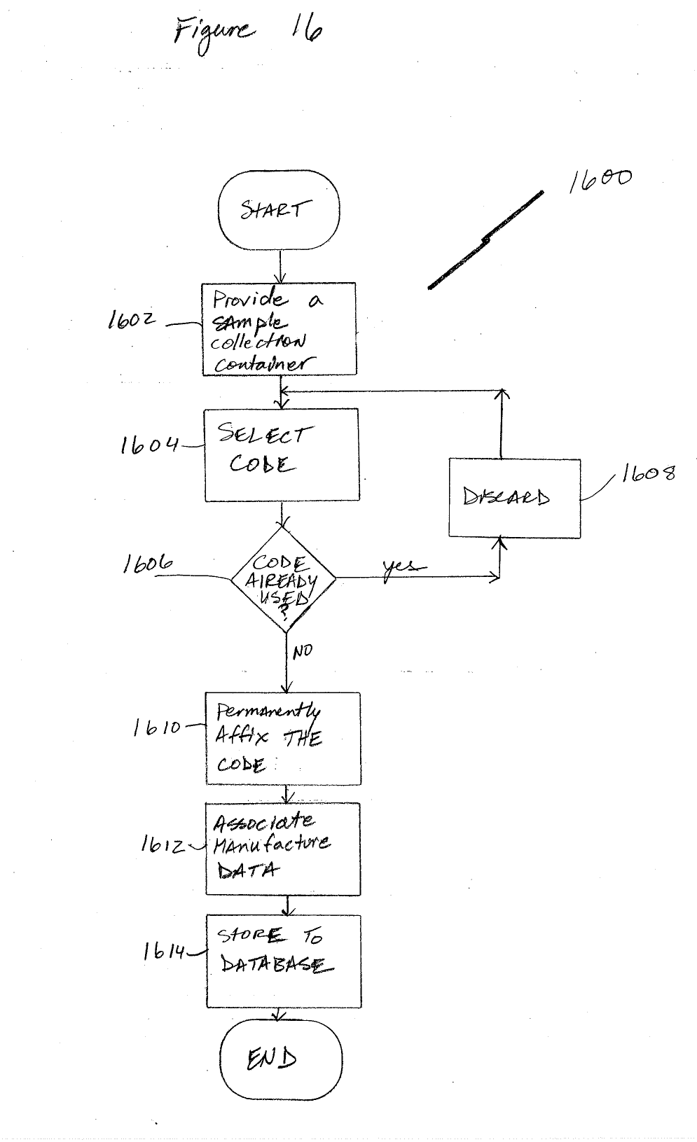

FIG. 17 is a flow diagram illustrating one embodiment of a method 1700 for taking inventory of sample collection containers in a medical environment. In step 1702 the code on a sample collection container is scanned. The method 1700 then stores the scanned code to the inventory database 1704. In addition to the code being stored to the inventory database, the manufacture data associated with the code may also be stored to the inventory database 1706. Thus, all of the manufacture data previously associated with a particular code, and saved to the manufacturer database, is now also contained in the inventory database.

In decision state 1708 the system determines if the product (here, the sample collection container) has expired. The date the system makes the determination (“the present date”) is programmed into modules and/or computers that are part of the system. The system determines if the product has expired by comparing the present date with the manufacturing data associated with the code in the inventory database. As discussed above, the manufacturing data can include information about the particular sample collection container including data about the date of its creation and any chemicals or other products that may have been added to it. The manufacturing data thus may include an expiration date of the sample collection container, which is a particular date after the creation of the sample collection container and/or after the addition of particular chemicals or other products to the sample collection container. If the present date is later than an expiration date associated with the manufacturing data then the sample collection container has expired. If the sample collection container has expired, the system creates an alert 1710 and then proceeds to the next decision state. This and other alerts hereinafter mentioned may be manifested in a variety of ways. An alert may be an audio and/or a visual alert to a user of the system. An alert might also notify a third party non-user. For example, if a physician's assistant is the user, then the third party receiving the alert might be a physician. Alerts might also be generated to be recorded in a database within the hospital system. (Because all databases within the hospital system may be connected, all databases would have access to the same alert.) If the sample collection container has not expired, then the system proceeds to the next decision state 1712 without creating an alert.

In decision state 1712, the system determines whether special handling is needed for the product that has been inventoried. The system contacts the inventory database, which includes information about the sample collection container inventory. As discussed above, the inventory database also includes the manufacturing data associated with the code. Among the manufacturing data may be information about the handling of a sample collection container (or containers). Special handling of sample collection containers may be required based upon the chemicals or other products added (that might require, for example, that the chemicals or other products in the sample collection container not be exposed to certain other chemicals); the fragile nature of the sample collection container (that might require, for example, that the sample collection container not be exposed to extreme or cold); or the particular shape of the sample collection container (requiring, for example, that the sample collection container not be inverted). In the event that special handling is required, an alert is generated 1714 and the method ends. In the event that special handling is not required, no alert is generated and the method ends.

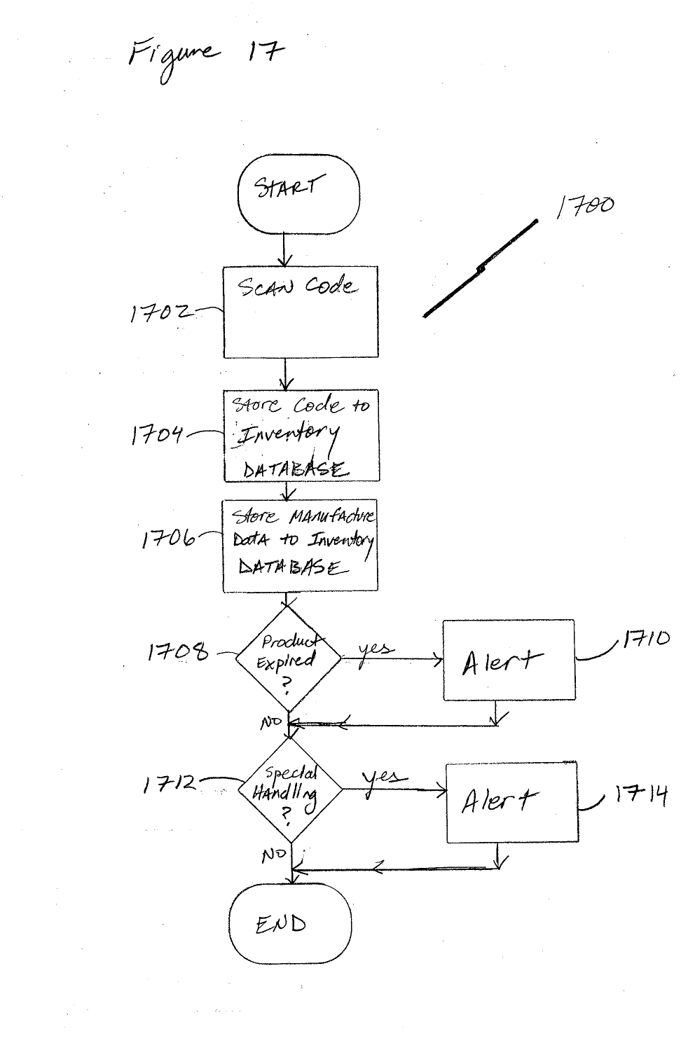

FIG. 18 is a flow diagram illustrating one embodiment of a method 1800 of using labeled sample collection containers within a hospital system. At step 1802 the code on the sample collection container is scanned and stored in the system. At step 1804 patient identification is scanned and stored in the system. Patient identification might include a wristband, a necklace, an implant or a tag worn by the patient. Patient information associated with patient identification might include, for example, a patient name, a patient age, a patient date of birth, a mother's name (in the case of an infant or a young child), insurance information, next of kin, a DNR, contact information for persons with power of attorney and/or decision-making capacity on behalf of the patient, a hospital name, a phlebotomist electronic signature, a time of use of the sample collection container, a patient record number, a patient diagnosis, a type of patient sample, a set of ordered tests, a doctor name, a doctor electronic signature or identification number and dates of treatment, and the like. The method 1800 then retrieves the patient record at a state 1806. At step 1808 a determination of what tests have been ordered by a physician is performed. The method 1800 then moves to a decision state 1810.

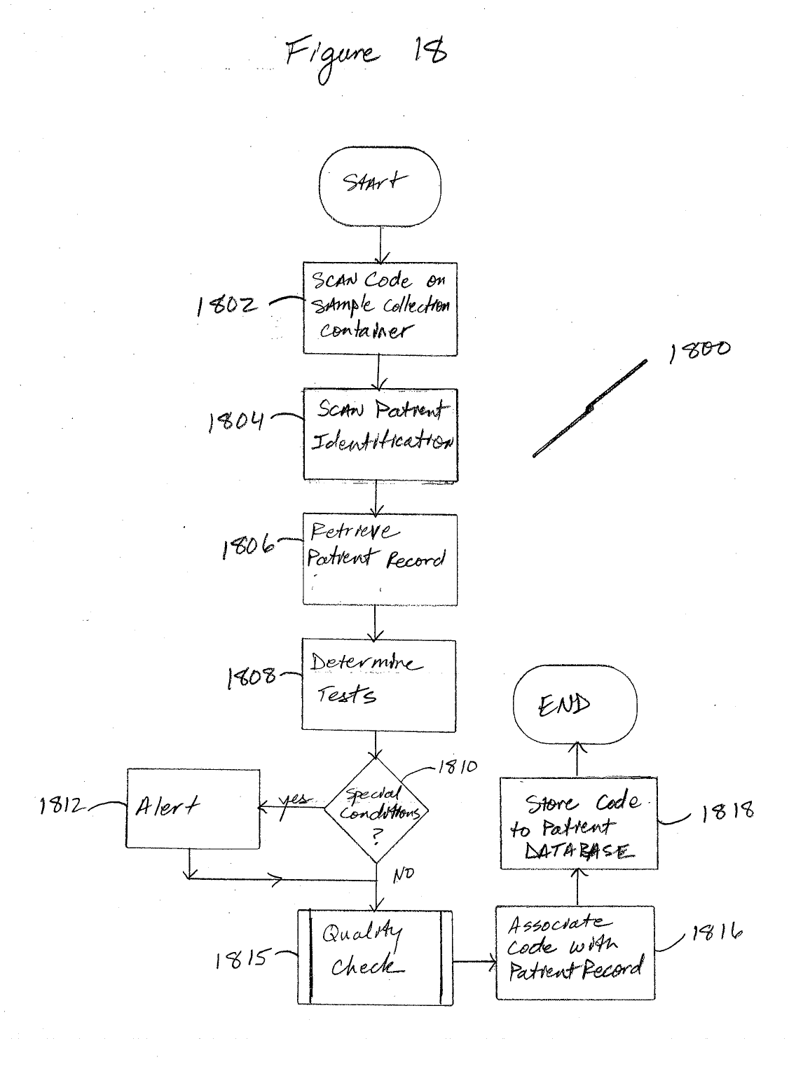

In decision state 1810 the system determines if the patient has any special conditions. Special conditions might include, for example, that the patient is a diabetic or that the patient is hemophiliac. If so, an alert is generated at a state 1812 and the system moves to a quality control process at a state 1815. If not, no alert is generated and the system moves to a quality control process at a state 1815. The system then moves through a quality control process at a state 1815, which will be discussed in greater detail in regard to FIG. 19. In step 1816 the system associates the scanned code with the patient record. The code is then stored to the patient database in step 1818. The patient database thus contains the scanned code associated with the patient information and the particular sample container.

FIG. 19 illustrates one embodiment of the quality control process 1815. In step 1820 the laboratory database is contacted by the system. In step 1822 the inventory database is contacted by the system. In decision state 1824, the system queries if the inventory (for example, the particular sample collection container) has expired. If so, the process generates an alert in step 1826 and moves to the next decision state. If not, the process advances to the next decision state without generating an alert. In decision state 1828, the system determines if the sample (in this case the sample contained within the sample collection container) has expired. If so, an alert is generated in step 1830 and the process ends. If not, the process ends without an alert.

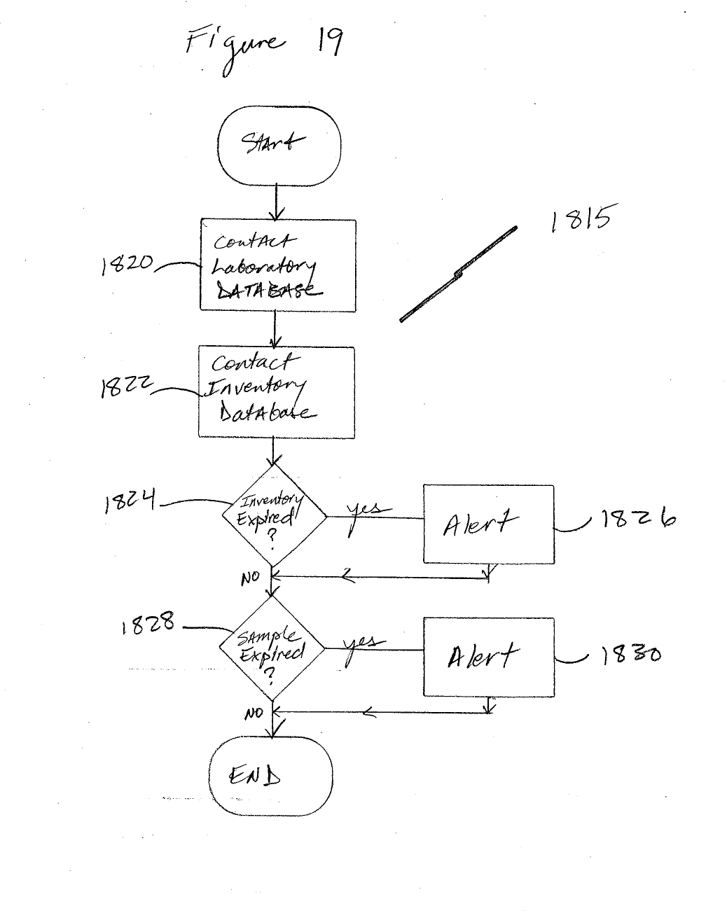

FIG. 20 is a flow diagram illustrating one embodiment of a method 1900 within a hospital system. In step 1902 the code on a sample collection container is scanned. In step 1904 a laboratory database is contacted. The method 1900 then moves to decision state 1906. In decision state 1906 the system determines whether the sample has expired. If so, an alert is generated and the system proceeds to step 1910. If not, then the method 1900 moves to step 1910 without generating an alert. In step 1910, a determination is made of what tests that have been ordered are to be performed. The method 1900 then moves to decision state 1912.

In decision state 1912, the a determination is made if there are any conflicts. Conflicts might include samples incompatible with the particular tests that have been ordered, sample collection containers incompatible with the particular tests ordered (for example, the sample has been ordered to be centrifuged and the sample container will not fit in the centrifuge) or possibly samples inconsistent with (and thus contaminated by) the particular chemicals contained within the sample collection container. If so, the system generates an alert at a state 1914 and then moves to step 1915. If not, no alert is generated and the system moves to step 1915.

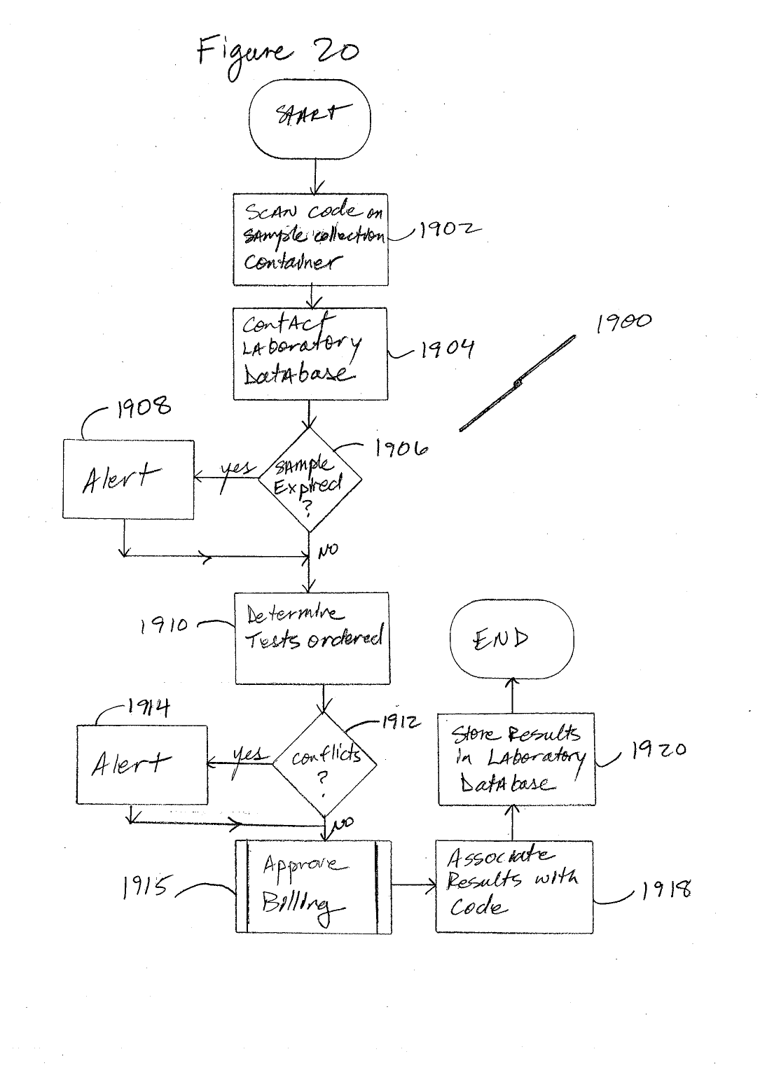

The system then moves through approve billing process 1915, which will be discussed in greater detail in regard to FIG. 21. In step 1918 the system associates the test results with the code. In step 1920 the test results are stored to in the laboratory database.

FIG. 21 illustrates one embodiment of approve billing process 1915. In step 1820, the system contacts the laboratory. In step 1932 the system retrieves insurance information from the patient database. In step 1934 the system compares the insurance information to the tests ordered. The system then moves to a decision state. In decision state 1936 the process queries if there is insurance coverage for the tests ordered. If not, the process then proceeds to step 1938, where an alert is generated and the process 1915 ends. If there is adequate insurance coverage, then the process 1915 ends without generating an alert.

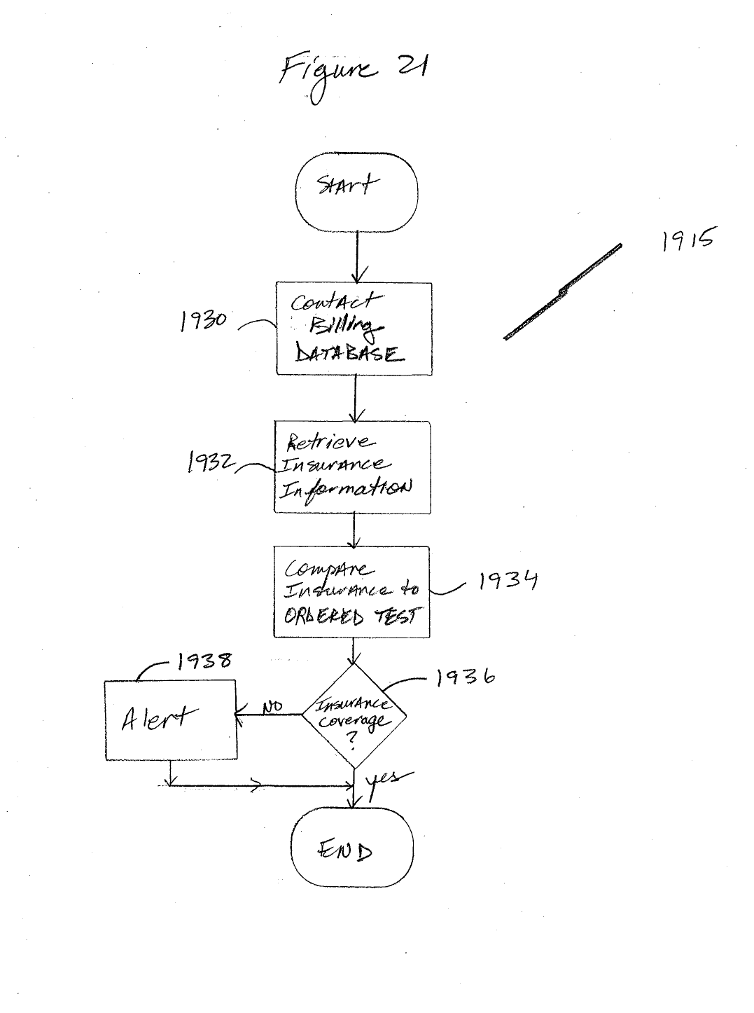

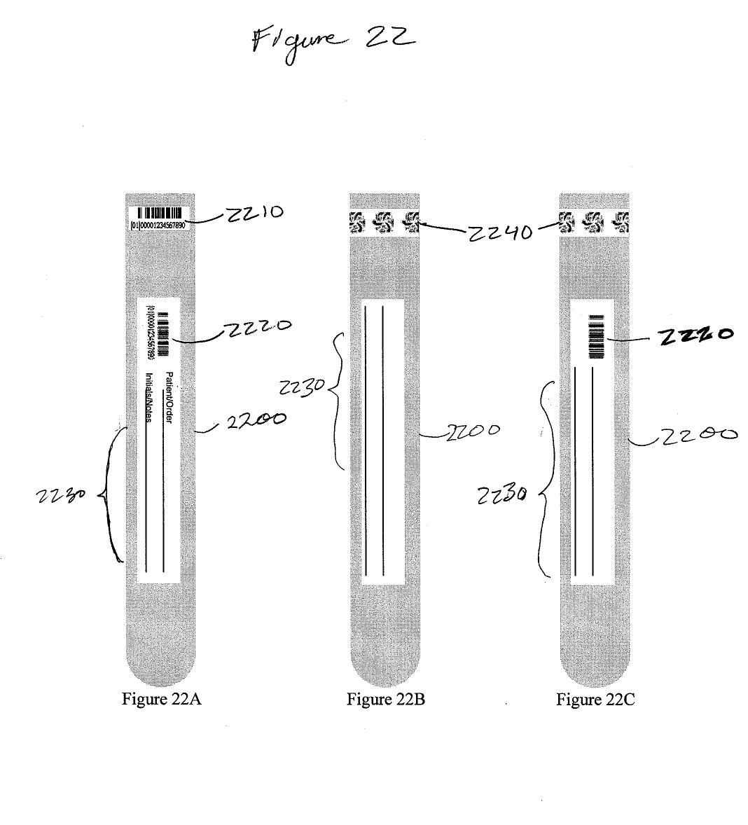

FIG. 22A represents one embodiment of a prior art sample collection container. The test tube 2200 displays a barcode 2210 and a barcode 2220. The barcode 2220 is imprinted on a label. The label has space for handwritten information 2230.

FIG. 22B represents one embodiment of a sample collection container. This embodiment shows intelliDOT DOTs 2240 affixed to the sample collection container 2200. In this manner, the information on the DOT can be read from any angle. This embodiment shows a label with an area for handwritten information 2230.

FIG. 22C represents another embodiment. DOTs 2240 are affixed to the sample collection container 2200. A label is attached to the sample collection 2200 with space for handwritten information 2230 and a barcode 2220.

### Sample Collection Containers for Mother's Milk

Certain types of sample collection containers are used in the medical environment to store or deliver mother's milk to an infant. In general a birth mother's milk is ideally suited for her infant because of the particular mix of antibodies and other nourishment that the birth mother transfers to her child. Birth mothers may provide milk to an infant child through breastfeeding (aka. nursing). In certain cases, however, new infants must stay in the hospital after a mother is discharged. In other cases, infants must return to a hospital or have other medical attention for an extended period without their mothers. In these cases, the birth mother may use a breast pump to extract her milk into a particular sample collection container for delivery to her infant. Theses types of sample collection containers may include jars, bottles, or other types of suitable containers.

Because there are particular nutritional benefits to the infant receiving his/her mother's milk, there is a need to ensure that a sample taken from a particular mother is actually delivered to her own child, and not another child. Methods for assuring that an infant receive the correct sample collection container with mother's milk can be similar to those outlined above. For example, the sample collection container may be manufactured with one or more labels including a code. In some embodiments codes may include all of the types of barcodes, 2-D codes or other types of codes discussed above for use with sample collection containers. In other embodiments, codes used for labeling sample collection containers used for mother's milk may include radio frequency tags. In the medical environment, the information associated with the code may include information about the infant, the mother, the time that the breast milk was “pumped” into the sample collection container, the storage of the sample collection container with the milk, the time of delivery, the doctors, the father (or other related individuals) or the other medically relevant information.

In some embodiments, methods of storing or delivering milk to an infant comprise providing a uniquely identifiable sample collection container configured to store milk for an infant, providing a label permanently affixed to the uniquely identifiable sample collection container, providing milk from a milk provider and delivering the sample collection container and the milk to an infant. In some embodiments the milk provider is a mother. In some embodiments, the milk provider is a “wet nurse” or breast milk bank. Tracking wet nurse milk pumped into a sample collection container (or banked breast milk placed in a sample collection container) may be performed through the same methods outlined above for mother's milk.

### CONCLUSION

It will be appreciated that the above-described system can be implemented in additional environments and is not limited to the health care industry. For example, the system may be implemented in industries and environments where precise inventory tracking and workflow management can be advantageous.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A method of manufacturing a uniquely identifiable sample collection container comprising:
providing a sample collection container with a permanently affixed code label; and
associating manufacture data of the sample collection container with the code label using a scanner configured to read the code label.

2. The method of claim 1, wherein the code label comprises at least one of a barcode and a DOT.

3. The method of claim 1, wherein manufacture data comprises at least one of a lot number, a place of manufacture, a type of sample tube, a date of manufacture, an expiration date and at least one chemical additive.

4. The method of claim 1, wherein the sample collection container is a sample tube.

5. A method of controlling processes in a medical work flow system comprising:
permanently affixing a unique code label to a sample collection container;
associating the sample collection container manufacture data with the code label; and
associating patient data with the code label.

6. The method of claim 5 further comprising providing the sample collection container to a health care worker.

7. The method of claim 5, wherein the code label comprises at least one of a barcode and a DOT.

8. The method of claim 5, wherein manufacture data comprises at least one of a lot number, a place of manufacture, a type of sample collection container, a date of manufacture, an expiration date and a chemical additive.

9. The method of claim 5 further comprising scanning a patient identification.

10. The method of claim 9, wherein patient identification comprises a wristband.

11. The method of claim 5 further comprising scanning a nurse identification badge.

12. The method of claim 5 further comprising scanning a hospital employee identification badge.

13. The method of claim 5, wherein patient data comprises at least one of a patient name, a patient age, a patient date of birth, a hospital name, a phlebotomist electronic signature, a time of use of the sample tube, a patient record number, a patient diagnosis, a type of patient sample and a set of ordered tests.

14. A uniquely identifiable sample collection container comprising:
sample collection container; and
a unique code permanently affixed to the sample collection container,
wherein the sample collection container manufacture data is associated with the code.

15. The sample collection container of claim 14, wherein the unique code comprises at least one of a barcode and a DOT.

16. The sample collection container of claim 14, wherein the manufacture information comprises at least one of a lot number, a place of manufacture, a type of sample tube, a date of manufacture, an expiration date and at least one chemical additive.

17. The sample collection container of claim 14, wherein the sample collection container is a sample tube.

18. A system for uniquely identifying sample collection container in a medical or research environment comprising:
sample collection container;
a unique code label permanently affixed to the sample collection container; and
a hand held scanner configured to cumulatively associate with the code label at least one of manufacturer data and patient data.

19. The system of claim 18, wherein the scanner is configured to alert a user to specific sample collection container manufacture data.

20. The system of claim 18, wherein manufacture data comprises at least one of a lot number, a place of manufacture, a type of sample tube, a date of manufacture, an expiration date and at least one chemical additive.

21. The system of claim 18, wherein the patient data comprises at least one of a patient name, a patient age, a patient date of birth, a hospital name, a phlebotomist electronic signature, a time of use of the sample tube, a patient record number, a patient diagnosis, a type of patient sample and a set of ordered tests.

22. The system of claim 18, wherein the hand held scanner further comprises a wireless transceiver.

23. The system of claim 18, wherein the hand held scanner further comprises a processor.

24. A method of storing or delivering milk to an infant comprising:
providing a uniquely identifiable sample collection container configured to store milk for an infant;
providing a label permanently affixed to the uniquely identifiable sample collection container, wherein the label comprises a code, wherein the code is associated with manufacture data about the sample collection container, patient data about the infant and the origin of the milk;
providing milk from a milk provider; and
delivering the sample collection container and the milk to an infant.

25. The method of claim 24 further comprising storing the sample collection container and the milk.

26. The method of claim 24, wherein the sample collection container is a bottle or a jar.
